(19) United States
(12) Patent Application Publication
(10) Pub. No.: US 2006/0159202 A1
(43) Pub. Date: Jul. 20, 2006

(54) Frequency converter for a spectral conversion of a start signal and method for a spectral conversion of a start signal

(76) Inventor: Marco Breiling, Erlangen (DE)

Correspondence Address: GLENN PATENT GROUP, 3475 EDISON WAY, SUITE L, MENLO PARK, CA, 94025, US

(21) Appl. No.: 11/300,263

(22) Filed: Dec. 13, 2005

(30) Foreign Application Priority Data
Dec. 13, 2004 (DE) 10 2004 059 939.4

(51) Int. Cl. H04L 27/22

(52) U.S. Cl. 375/332

(57) ABSTRACT

A frequency converter for a spectral conversion of a start signal having a current frequency to an end signal having a target frequency, wherein the start signal includes an I component having a plurality of I component values and a Q component having a plurality of Q component values, comprises means for selecting a plurality of sub-signals based on the I component or the Q component, wherein a sub-signal, depending on a raster, includes selectable I component values, and wherein another sub-signal, depending on the raster, includes selected Q component values. Further, the frequency converter comprises means for weighting each of the plurality of sub-signals, wherein means for weighting is implemented to weight each of the plurality of sub-signals with one weighting factor each to obtain a plurality of weighting signals. Additionally, the frequency converter comprises means for summing the plurality of weighting signals to obtain the end signal having the target frequency. By such a frequency converter and a corresponding method for a spectral conversion, it is possible, in simply realizable way regarding numerics and circuit engineering, to provide a spectral frequency converter to convert a start signal having a current frequency to an end signal having a target frequency.

### BACKGROUND OF THE INVENTION

1. Field of the Invention

The present invention relates to the partial field of digital signal processing, and, in particular, the present invention relates to a frequency converter (mixer), as it is required for a spectral conversion of a signal from one frequency to another frequency. In particular, such a frequency converter may be used in high-frequency technology or in telecommunications.

2. Description of the Related Art

In telecommunications, to shift a signal from a current frequency (current frequency) into a higher transmission frequency (target frequency) mainly mixers are used. For such a shifting, for example in the transmitter several different possibilities are possible. First, a signal having a low bandwidth B_{low} may be shifted to different center frequencies within a large bandwidth B. If this center frequency is constant over a longer period of time, then this means nothing but the selection of a subband within the larger frequency band. Such a proceeding is referred to as “tuning”. If the center frequency to which the signal is to be shifted varies relatively fast, such a system is referred to as a frequency-hopping system or a spread-spectrum system. As an alternative, also within a large bandwidth B several transmission signals may be emitted in parallel in the frequency multiplexer with a respectively low bandwidth B_{low}.

Analog to these proceedings in the transmitter, the respective receivers are to be implemented accordingly. This means on the one hand that a subband of the large bandwidth B is to be selected when the center frequency of the transmitted signal is constant over a longer period of time. The tuning is then performed to the predetermined center frequency. If the center frequency is varied relatively fast, as it is the case with a frequency-hopping system, also in the receiver a fast temporal change of the center frequency of the transmitted signal has to take place. If several transmit signals have been sent out in parallel in the frequency multiplexer, also a parallel reception of those several frequency-multiplexed signals within the larger bandwidth B has to take place.

Conventionally, for an above-indicated tuning system and a frequency-hopping system an analog or digital mixer is used, wherein the digital mixing conventionally takes place with one single mixer stage. In an analog mixer, a high expense in circuit technology is necessary, as for a precise mixing to the target frequency highly accurate mixer members are required which substantially increase the costs of the transmitter to be manufactured. It is to be noted with regard to a digital mixer that in certain respects a high expense in terms of circuit engineering (or numerics, respectively) is required when the signal is to be mixed onto a freely selectable random target frequency.

For a parallel transmitting and receiving of several frequency sub-bands, further frequently the OFDM method (orthogonal frequency division multiplexing) and related multicarrier or multitone modulation methods, respectively, are used. The same require, by the use of the Fourier transformation, a partially substantial computational overhead, in particular if only a few of the frequency sub-bands from a large frequency band having several individual frequency sub-bands are required.

Conventional mixers may here be implemented in a similar way to the mixer device 2400, as it is illustrated in FIG. 24A. The mixer device 2400 may comprise a mixer 2402, a low-pass filter 2404 and a downsampler 2406. The mixer 2402 includes an input 2408 for receiving a signal 2410 to be mixed. Further, the mixer 2402 includes an output 2412 for outputting the signal 2414 converted from the current frequency to an intermediate frequency which is fed to the low-pass filter 2404 via an input 2416 of the same. Further, the low-pass filter 2404 includes an output 2418 for outputting a frequency-converted low-pass-filtered signal 2420 which may be supplied to the downsampler 2406 via an input 2422 of the same. The downsampler 2406 includes an output 2424 for outputting a downsampled signal 2426 which is simultaneously an output signal output from the mixer device 2400.

If the input signal 2410 having the current frequency is supplied to the mixer device 2400, wherein the start signal 2410 is based on a first sampling frequency defining a distance of two time-discrete signal values, the mixer 2402 performs a conversion of the current frequency to an intermediate frequency, from which the intermediate frequency signal 2414 results. In this intermediate frequency signal 2414 only the frequency on which the start signal 2410 is located (i.e. the current frequency) is converted to an intermediate frequency, wherein the sampling frequency is not changed by the mixer 2402. In a suitable selection of the current frequency and the sampling frequency now in an easy way regarding numerics or circuit engineering a mixing to the intermediate frequency signal 2414 having the intermediate frequency may be realized. If, for example, the spectral interval between the current frequency and the intermediate frequency, regarding the magnitude, is a quarter of the sampling frequency, a mixing may be performed by a multiplication with the values 1, i, −1 and −i or by a negation of real part or imaginary part values, respectively, of the start signal 2410, and by exchanging real and imaginary part values of start signal values of the start signal 2410. Hereupon, a low-pass filtering of the intermediate frequency signal 2414 having the first sampling frequency is performed by the low-pass filter 2404, from which a low-pass-filtered intermediate frequency signal 2402 results which is again based on the first sampling frequency. By the downsampler 2406 then a downsampling of the low-pass-filtered intermediate frequency signal 2402 is performed, whereupon a reduction of the sampling frequency takes place, without again spectrally converting the signal. Such an approach which is easy to implement with regard to numerics or hardware technology is, for example, disclosed in Marvin E. Frerking, Digital Signal Processing in Communication Systems, Kluwer Academic Pulishers.

Such an approach of a mixer 2402 easy to be realized in numerics or circuit engineering has the disadvantage that by the predetermined connection between the current frequency and the sampling frequency only intermediate frequencies may be obtained which are arranged in a spectral interval of a quarter of the sampling frequency around the current frequency. This reduces the applicability of such a mixer 2402 which is efficiently realized regarding numerics or circuit engineering. If also intermediate frequencies are to be obtained comprising a different distance to the current frequency than a quarter of the sampling frequency, a multiplication of the individual start signal values of the start signal 2410 with the rotating complex pointer e^{j2π2π}^{_{c}}^{/f}^{_{f}} is necessary, wherein k is a running index of the start signal values, f_{c} is the desired center frequency (i.e. the intermediate frequency) and fₛ is the sampling frequency of a signal. It is to be considered, however, that in the multiplication of the start signal values with the rotating complex pointer not only purely real or purely imaginary multiplication factors are to be used, respectively, but that the used multiplication factors comprise real and imaginary parts. By this, an efficient solution regarding numerics and circuit engineering, as it was outlined above, may not be used. A mixer would be desired, however, that offers the possibility to be able to perform the mixing of start signal values from a current frequency to any intermediate frequency in an efficient way regarding numerics and circuit engineering.

It is a further disadvantage of a conventional mixer device as it is, for example, characterized by the conventional mixer device 2400 in FIG. 24, that for a spectral conversion, a low-pass filtering and subsequent subsampling two or more individual stages are required. This leads to a substantial overhead in numerics or circuit engineering, respectively, when realizing such a spectral conversion with a subsequent downsampling as a computer algorithm or as a circuit structure.

### SUMMARY OF THE INVENTION

It is thus the object of the present invention to provide a possibility to realize a spectral conversion combined with a downsampling in a simpler and more efficient way as compared to conventional approaches.

In accordance with a first aspect, the present invention provides a frequency converter for a spectral conversion of a start signal having a current frequency to an end signal having a target frequency, wherein the start signal includes an I component having a plurality of I component values and a Q component having a plurality of Q component values, the frequency converter further having means for selecting a plurality of sub-signals based on the I component or the Q component, wherein a sub-signal, depending on a raster, includes selectable I component values, and wherein another sub-signal, depending on the raster, includes selected Q component values; means for weighting of each of the plurality of sub-signals, wherein means for weighting is implemented to weight each of the plurality of sub-signals with respectively one weighting factor in order to obtain a plurality of weighting signals; and means for summing the plurality of weighting signals to obtain the end signal having the target frequency.

In accordance with a second aspect, the present invention provides a method for a spectral conversion of a start signal having a current frequency to an end signal having a target frequency, wherein the start signal includes an I component having a plurality of I component values and a Q component having a plurality of Q component values, and wherein the method for a spectral conversion further having the steps of selecting a plurality of sub-signals based on the I component or the Q component, wherein a sub-signal, depending on a raster, includes selectable I component values, and wherein another sub-signal, depending on the raster, includes selected Q component values; weighting each of the plurality of sub-signals, wherein each of the plurality of sub-signals is weighted with a weighting factor each to obtain a plurality of weighting signals; and summing the plurality of weighting signals to obtain the end signal having the target frequency.

In accordance with a third aspect, the present invention provides a computer program for performing the above mentioned method, when the computer program runs on a computer.

The present invention is based on the finding that by an interconnection of means for selecting, means for weighting and means for summing an optimized spectral conversion and a reduction of the sampling rate is possible, as now already in the spectral conversion first preparations for a sampling rate reduction are performed. This results in particular from the fact that means for selecting may be used advantageously to split up the start signal into several sub-signals (partial signals), wherein the sub-signals are respectively based on the I and Q component values of the signal. By this means for selecting, thus sub-signals are provided in which preferably an m^{th} sub-signal includes a sequence based on each fourth I component value beginning with the m^{th} I coefficient value or wherein an m^{th} sub-signal includes a sequence based on each fourth Q component value beginning with an m^{th} Q coefficient value, wherein m is a count index with the values 1, 2, 3, or 4. Means for selecting is thus, for example, implemented to provide a first sub-signal based on a sequence of I component values of the signal, to provide a second sub-signal based on a sequence of Q component values of the signal and to provide a third sub-signal based on a sequence of I coefficient values and to provide a fourth sub-signal based on a sequence of Q coefficient values.

Further, by the inventive approach, for example, the sub-signals may be weighted by means for weighting such that each sub-signal is multiplied with a weighting factor, whereby several weighting signals are obtained. Preferably, means for weighting may be implemented to perform the weighting according to an FIR filter regulation (FIR=finite impulse response). Preferably, thus the first sub-signal may be weighted with one or several weighting factors to obtain a first weighting signal, the second sub-signal may be weighted with one or several weighting factors to obtain a second weighting signal, the third sub-signal may be weighted with one or several weighting factors to obtain a third weighting signal and the fourth sub-signal may be weighted with one or several weighting factors to obtain a fourth weighting signal. Subsequently, the weighting signals are summed in means for summing to obtain the end signal having the target frequency.

It is thus an advantage of the present invention that already in means for selecting a split-up of the signal into several sub-signals is performed, wherein preferably the signal is split up into a number of sub-signals corresponding to a downsampling factor. By this, already the basis for a downsampling to be performed using the downsampling factor is provided. Further, means for weighting, for example weighting each of the sub-signals, may be implemented such that it performs a low-pass filtering. The filtering may then be performed in the form of a polyphase filtering with the individual sub-signals as polyphase signals. The advantage of such a low-pass polyphase filtering is that several signal values do not have to be multiplied one after the other by several filter coefficients and be subsequently summed, but that rather by splitting up into individual polyphase signals (i.e. sub-signals) a parallelization of the processing is possible. This further results in a lower work cycle frequency of the frequency converter than would be required in a conventional, serial FIR low-pass filtering. A reduction of the clock frequency further results in an increase of the efficiency with regard to numerics or circuit engineering, whereby a cost reduction and (due to the lower clock frequency) also a lower power consumption of the proposed frequency converter with regard to the conventional frequency converter may be realized. Finally, in means for summing a merging of the individual weighting signals takes place, for example corresponding to the low-pass-filtered polyphase signals (i.e. the low-pass-filtered sub-signals). Such a summation thus corresponds to the summation of individual weighted samples, as it takes place according to the known (serial) FIR filter regulation.

Further, already in means for selecting, by a suitable selection of I component values or Q component values for the sub-signals, already first steps for the rearrangement of real and imaginary part values of the signal values required from the known mixing method may be performed. If now additionally a negation of corresponding real or imaginary part values, i.e. a negation of values of a sub-signal with regard to the I or Q component values is performed, thus simultaneously the above-described mixer with the frequency conversion of one quarter of the sampling frequency may be realized efficiently. In means for selecting or in means for weighting, still again a negation of real or imaginary part values of the signal may be performed. This means that already by means for selecting (and partially by means for weighting) the mixer function may be formed.

According to an embodiment of the present invention, means for selecting may be implemented to provide a first, second and fourth auxiliary signal. Here, further, means for weighting may be implemented to weight the first auxiliary signal with one or several weighting coefficients to obtain a fifth weighting signal, to weight the second auxiliary signal with one or several weighting coefficients to obtain a sixth weighting signal, to weight the third auxiliary signal with one or several weighting coefficients to obtain a seventh weighting signal and to weight the fourth auxiliary signal with one or several weighting coefficients to obtain an eighth weighting signal. Preferably, the fifth, sixth, seventh and eighth weighting signal are added in further means for summing, to obtain a further end signal. Preferably, means for selecting may also be implemented to calculate the further end signal based on the first, second, third and fourth auxiliary signal such that it is a complementary signal to the end signal. To this end, means for selecting may in particular be implemented so that each of the first, second, third and fourth auxiliary signals corresponds to a complementary sub-signal of the first, second, third or fourth sub-signals.

Further, means for weighting may preferably be implemented to weight the first, second, third and fourth auxiliary signal in an analog way, like the first, second, third and fourth sub-signal, to obtain the fifth, sixth, seventh and eighth weighting signal. By adding the fifth, sixth, seventh and eighth weighting signal of means for weighting, thus the further end signal may be provided corresponding to a complementary signal to the end signal by a suitable selection of I or Q component values in means for selecting.

Such an approach comprising the calculation of the further end signal offers the advantage that already in a parallel calculation of the end signal and the further end signal (complementary signal) a clear acceleration of the determination of a signal rendered for a further processing is possible, wherein the signal rendered for the further processing comprises a component corresponding to the end signal and a component corresponding to the complementary signal. In this case, by a corresponding implementation of means for selecting, further means for weighting and further means for summing, a comparatively low additional overhead as compared to conventional frequency converters is necessary.

### BRIEF DESCRIPTION OF THE DRAWINGS

Preferred embodiments of the present invention are explained in more detail in the following with reference to the accompanying drawings, in which:

FIG. 1A shows an embodiment of the inventive frequency converter for a spectral conversion;

FIG. 1B shows a further embodiment of the inventive frequency converter for a spectral conversion;

FIG. 2 shows an illustration of the obtainable target frequencies of several cascaded mixers of FIGS. 1A or 1B;

FIG. 3 shows a tabular illustration of values of the cosine and the sine function as they occur in a positive or negative frequency shift according to the inventive approach;

FIG. 4 shows a tabular illustration of real and imaginary part values in a multiplication of the signal input values according to the approach illustrated in FIG. 5;

FIG. 5 shows a block diagram of the approach of the multiplication of a signal value with a set of multiplication factors;

FIG. 6 shows a block diagram of an upsampler which may be used in connection with the inventive approach;

FIG. 7 shows a block diagram representing a detailed illustration of the block shown in FIG. 6;

FIG. 8 shows a block diagram representing a detailed illustration of the block illustrated in FIG. 7;

FIG. 9 shows a tabular illustration of filter coefficients according to an embodiment of the block illustrated in FIG. 8;

FIG. 10 shows a block diagram representing a detailed illustration of a block of FIG. 7;

FIG. 11A shows a block diagram representing an embodiment of a mixer when using the mixer as a down-mixer (down-converter);

FIG. 11B shows a block diagram of a possible use of the outputs of the mixer shown in FIG. 11A using several correlators;

FIG. 11C shows a diagram of a possible occupation of frequencies in the use of the correlators illustrated in FIG. 11B;

FIG. 11D shows a further diagram of a possible occupation of frequencies in the use of the correlators illustrated in FIG. 11B;

FIG. 12 is a tabular illustration of the word width, data rate and data type of the signals illustrated in FIG. 11A;

FIG. 13 is a tabular illustration of the conversion of an input signal of a block illustrated in FIG. 11A into an output signal of a block using a specific parameter;

FIG. 14 shows a block diagram representing a detailed structure of a block illustrated in FIG. 11A;

FIG. 15 is a tabular representation of word widths, data rates and data types of signals represented in FIG. 14;

FIG. 16 is a tabular illustration of the allocation of signal values to filter coefficients in the time course;

FIG. 17 is a tabular illustration of the allocation of signal values to different polyphases of a polyphase filter;

FIG. 18 is a block diagram of a further embodiment of the present invention;

FIG. 19 is a tabular illustration of the allocation of real or imaginary parts, respectively, of signal values to different polyphases of a polyphase filter;

FIG. 20 is a tabular illustration of an allocation of real and imaginary part values of signal values to polyphases of a polyphase filter;

FIG. 21 is a tabular illustration of the allocation of real and imaginary part values of signal values to individual polyphases of a polyphase filter;

FIG. 22 shows a tabular illustration of real and imaginary part values for individual polyphase filters and the result resulting from the polyphase filters;

FIG. 23 shows a tabular illustration of a calculation regulation for real and imaginary part values of an output signal of the polyphase filter considering a frequency shift in the positive or negative direction or preventing a frequency shift; and

FIG. 24 shows a block diagram of a conventional mixer device.

### DESCRIPTION OF THE PREFERRED EMBODIMENTS

In the following description of the preferred embodiments of the present invention, for like elements illustrated in the different drawings like or similar reference numerals are used, wherein a repeated description of those elements is omitted.

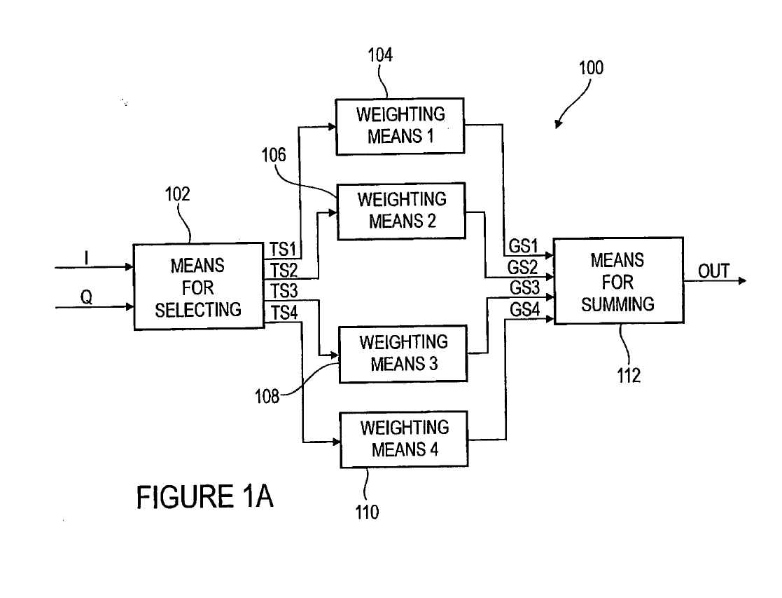

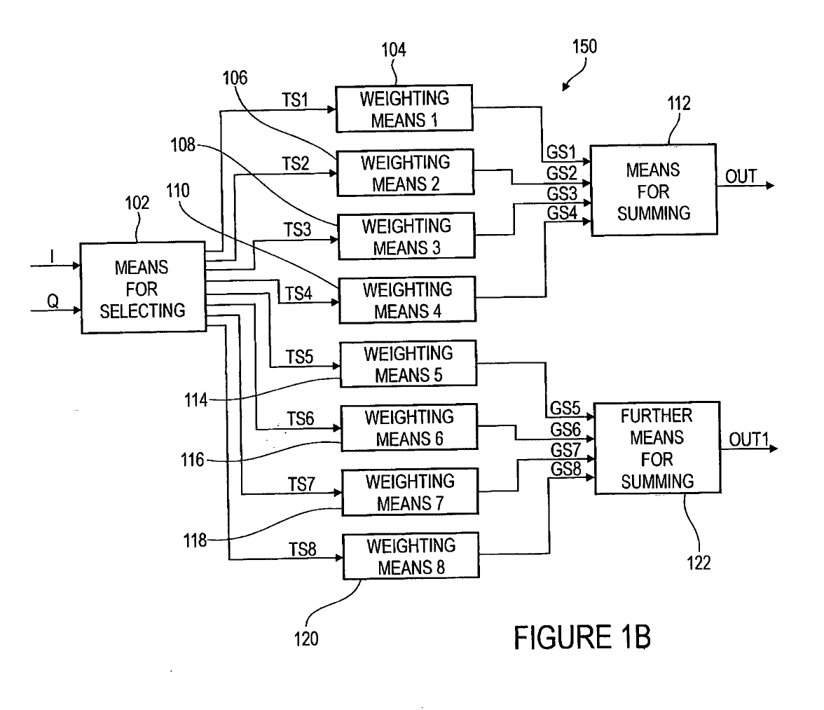

FIG. 1A shows an embodiment of the inventive frequency converter for a spectral conversion of a start signal having a current frequency to an end signal having a target frequency. Here, a frequency converter 100 includes means for selecting 102, first weighting means 104, second weighting means 106, third weighting means 108, fourth weighting means 110 and means for summing 112. Means 102 for selecting includes a first input I for receiving I component values of an I component of the start signal and a second input Q for receiving Q component values of a Q component of the start signal. Further, means 102 for selecting includes a first output for outputting a first sub-signal TS₁, a second output for outputting a second sub-signal TS₂, a third output for outputting a third sub-signal TS₃ and an output for outputting a fourth sub-signal TS₄.

First weighting means 104 includes an input for receiving the first sub-signal TS₁ and an output for outputting a first weighting signal GS₁. Second weighting means 106 includes an input for receiving the second sub-signal TS₂ and an output for outputting the second weighting signal GS₂. Third weighting means 108 includes an input for receiving the third sub-signal TS₃ and an output for outputting a third weighting signal GS₃. Fourth weighting means 110 includes an input for receiving the fourth sub-signal TS₄ and an output for outputting a fourth weighting signal GS₄.

Means 112 for summing includes a first input for receiving the first weighting signal GS₁, a second input for receiving the second weighting signal GS₂, a third input for receiving the third weighting signal GS₃ and a fourth input for receiving the fourth weighting signal GS₄. Further, means 112 for summing includes an output OUT for outputting the end signal.

If means 102 for selecting is provided with a start signal, i.e. if at the first input I component values of the I component of the signal and at the second input Q component values of the Q component of the start signal are applied, then in means 102 for selecting from this a first sub-signal TS₁, a second sub-signal TS₂, a third sub-signal TS₃ and a fourth sub-signal TS₄ may be determined. Each of those sub-signals may be based on a sequence of I component values or on a sequence of Q component values. For example, the first sub-signal TS₁ may be based on a sequence of each fourth I component value beginning with the first I coefficient value. The second sub-signal may, for example, be based on a sequence of every fourth Q component value beginning with the second Q component value. The third sub-signal TS₃ may in this example be based on a sequence of every fourth, negated I component value beginning with the third I component value. Further, in this embodiment, the fourth sub-signal TS₄ may include a sequence based on each fourth negated Q component value beginning with the fourth Q component value. According to this embodiment, means 102 for selecting may thus also be implemented to negate I component values or Q component values of the start signal.

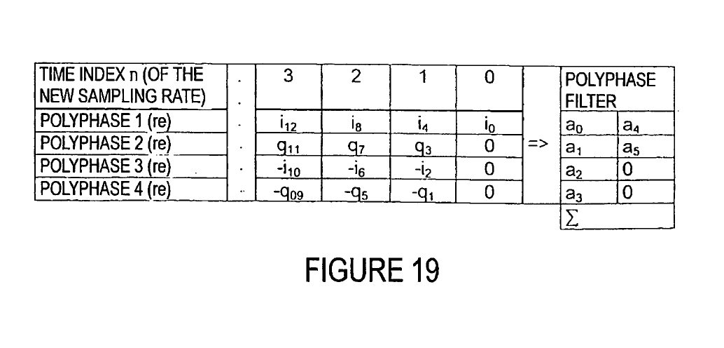

First weighting means 104, second weighting means 106, third weighting means 108 and fourth weighting means 110 may be implemented to transform the first, second, third and fourth sub-signals TS₁ to TS₄ into the first to fourth weighting signals GS₁ to GS₄. Here, one of the weighting means may respectively be implemented to multiply a component of one of the sub-signals by one or several weighting factors. Should one of the first to fourth sub-signals TS₁ to TS₄ be multiplied in the corresponding weighting means by several weighting factors, such a weighting may, for example, be performed by performing an FIR filter regulation. Further, the weighting factors may be selected such that in the first to fourth weighting means 104 to 110 a low-pass filtering may be performed. A selection of the weighting factors and the distribution of the weighting factors to weighting means 104 to 110 illustrated in FIG. 1A is discussed in more detail in the following (in particular with reference to FIGS. 19 to 23).

If weighting signals GS₁ to GS₄ are provided, in means 112 for summing the first weighting signal GS₁, the second weighting signal GS₂, the third weighting signal GS₃ and the fourth weighting signal GS₄ are summed to obtain the output signal OUT which is in the regarded embodiment simultaneously the end signal having the target frequency. Here, means 112 for summing may be implemented to add a first value of the first weighting signal GS₁ to a first value of the second weighting signal GS₂, a first value of the third weighting signal GS₃ to a first value of the fourth weighting signal GS₄ in order to obtain a first value of the output signal OUT. Subsequently, a second value of the first weighting signal GS₁ may be summed with a second value of the second weighting signal GS₂, a second value of the third weighting signal GS₃ and a second value of the fourth weighting signal GS₄ to obtain a second value of the output signal OUT. Here, the second values of the signals TS₁ to TS₄, GS₁ to GS₄ and the output signal OUT respectively follow the first values of the corresponding signals. By a thus implemented frequency converter 100, in particular by the above-described exemplary division of the sub-signal TS₁ to TS₄, an output signal OUT results corresponding to an I component (i.e. a real part) of the end signal having the target frequency.

Further, means for weighting 104 to 110 may also be implemented to perform a negation of values of the sub-signals TS₁ to TS₄ when, for example, a corresponding negation of I and Q component values may not be performed in means 102 for selecting.

By such a frequency converter 100 it is thus possible, in an efficient way with regard to numerics or circuit engineering, respectively, to shift a start signal with a current frequency to an intermediate frequency, for example low-pass filter the signal shifted to the intermediate frequency and downsample the low-pass-filtered signal. In particular, when the start signal is a sequence of time-discrete values, wherein two subsequent values are separated by a time interval defining a sampling frequency, such a frequency converter 100 may be realized in an especially efficient way when a spectral interval between the current frequency and the intermediate frequency corresponds to a quarter of the sampling frequency and a downsampling is performed by a downsampling factor of 4.

The efficiency with regard to numerics or circuit engineering, respectively, then in particular results from the fact that, apart from a simple realization of the mixer using negation and exchange operations, also a splitting-up of the start signal, for example into four polyphase signals, is possible which may, on the one hand, be used for realizing the mixer function and, on the other hand, already for providing the downsampling function. By such a split-up and a parallel processing, the frequency converter 100 may be operated with a clock rate which is clearly lower than the clock rate with corresponding conventional frequency converters. This leads to the possibility to be able to provide a less expensive frequency converter.

Further, by a corresponding selection of the first to fourth sub-signals TS₁ to TS₄ also an output signal OUT may be obtained which corresponds to a Q component of the end signal having the target frequency. A more accurate selection of the values of the sub-signals TS₁ to TS₄ with regard to the values at the two inputs I and Q of means 102 for selecting is explained in more detail in the following with reference to FIGS. 19 to 23.

As an end signal having the target frequency may then be evaluated especially well and fast, if apart from the I component of the end signal, simultaneously also a Q component of the end signal (i.e. a complementary signal corresponding to the end signal) is provided, by an extension of the frequency converter illustrated in FIG. 1A according to FIG. 1B providing such a complementary signal may be achieved.

For this purpose, a frequency converter 150 comprises means 102 for selecting which may, apart from the first to fourth sub-signals TS₁ to TS₄, also provide a fifth to eighth sub-signal TS₅ to TS₈. Further, the frequency converter 150 comprises a fifth to eighth weighting means 114, 116, 118 and 120 which are respectively implemented to correspondingly output a fifth, sixth, seventh and eighth weighting signal GS₅ to GS₈. Further, the frequency converter 150 comprises further means 122 for summing which is implemented to sum the fifth to eight weighting signals GS₅ to GS₈ and correspondingly output a further end signal at a further output OUT1.

The interconnection of fifth weighting means 114, sixth weighting means 116, seventh weighting means 118, eighth weighting means 120 with further means 122 for summing is here performed analog to the interconnection of first weighting means 104, second weighting means 106, third weighting means 108,the fourth weighting means 110 with means 112 for summing. Further, the functionality of fifth to eighth weighting means 114 to 120 and further means 122 for summing corresponds to the functionality of first to fourth weighting means 104 to 110 and means 112 for summing. By a suitable selection of the fifth to eighth sub-signals TS₅ to TS₈ by means 102 for selecting, thus a further output signal OUT1 may be provided which is complementary to the output signal OUT. The selection of the fifth to eighth sub-signal TS₅ to TS₈ with regard to the first to fourth sub-signal TS₁ to T₄ is explained in more detail in the following with reference to FIGS. 19 to 23.

Further, also a frequency converter like the frequency converter 150 illustrated in FIG. 1B may be cascaded, i.e. a first frequency converter according to FIG. 1B may be connected upstream to a second frequency converter according to FIG. 1B. In this case, the output signal OUT of the first frequency converter would have to be selected as an I component of an input signal of the second frequency converter, and the further output signal OUT1 of the first frequency converter would have to be selected as the Q component of the input signal of the second frequency converter.

In this context it is further to be noted that the term of “digital mixing” of a complex baseband signal is the multiplication of a baseband signal with a rotating complex pointer e^{j2πkf}^{_{c}}^{/f}^{ₛ}, wherein k is a running index of a sample of the complex baseband signal (or input signal), f_{c} is the desired new carrier (i.e. center) frequency and fₛ is the sampling frequency. If the special cases f_{c}=0 or ±fₛ/4 are selected, then the rotating complex pointer only takes on the values of ±1 and ±j. When the complex input signal is present in I and Q components, then these multiplications may very easily be achieved by a negation and a multiplexing of the two components, e.g. a multiplication with −j means: I_{output signal}=Q_{input signal} and Q_{output signal}=−I_{input signal}. With this above-illustrated principle, a mixing onto three frequency sub-bands with the center frequencies f_{c}=0, f_{c}=+fₛ/4 and f_{c}=−fₛ/4 may be realized.

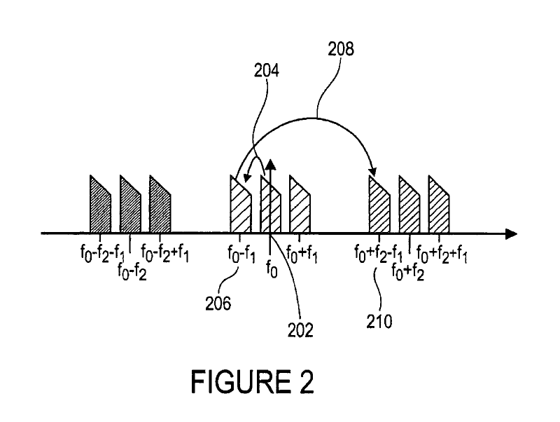

Using a frequency distribution illustrated in FIG. 2, a possible up- and down-conversion is to be explained in more detail by the cascading. In this connection it is to be noted that an up-conversion only serves for illustration purposes, that the inventive approach, however, substantially relates to down-conversion.

In order to be able to use such an above-described digital mixing which is simple to realize for a down-conversion, now a cascade-connection of the mixers explained in more detail above may be performed, wherein before a mixing with the second of the cascaded mixers a conversion of the sampling frequency takes place. For such a cascaded mixer, for example in the first mixer stage, the input signal having a first (low) sampling frequency fₛ₁ may be brought onto the center frequencies f_{c1}=0, f_{c1}=+fₛ₁/4=+f₁ or f_{c1}=−fₛ₁/4=−f₁ by the first mixer.

Subsequently, an upsampling (i.e. a sampling frequency increase), for example by the factor 4 onto a second (higher) sampling frequency fₛ₂ takes place. Part of the generation of the fₛ₂ samples is here preferably an insertion of “0” values (samples) after each fₛ₁ sample (i.e. for this example with fₛ₂=4*fₛ₁ an insertion of three “0” values). In the following, a low-pass filtering is performed in order to preserve only the upsampled fₛ₁ signal and not its spectral images (i.e. its spectral image frequencies resulting in upsampling) at multiples of the first sampling frequency fₛ₁. Subsequently, again a digital mixing may be performed, this time onto the center frequencies f_{c2}=0, f_{c2}=+fₛ₂/4=+f₂ or f_{c2}=−fₛ₂/4=−f₂. Altogether, in this way, based on a signal in the current frequency, nine different center frequencies f_{c} in relation to the current frequency f₀ may be obtained:
f_{c}=f₀−f₂−f₁,
f_{c}=f₀−f₂+0,
f_{c}=f₀−f₂+f₁,
f_{c}=f₀f₁,
f_{c}=f₀,
f_{c}=f₀+f₁,
f_{c}=fᵢ+f₂−f₁,
f_{c}=f₀+f₂,
and f_{c}=f₀+f₂+f₁. Such a frequency distribution is illustrated as an example in FIG. 2.

A mixer may now, for example, mix a signal of the current frequency f₀ 202, i.e. the center frequency f_{c}=f₀ by a first mixing 204 to the center frequency f_{c}=f₀−f₁. Subsequently, after an upsampling an increase of the sampling frequency takes place, whereupon a mixing 208 of the signal now located in the intermediate frequency with the center frequency f_{c}=f₀−f₁ onto the target frequency 210 with the center frequency f_{c}=f₀+f₂−f₁ may be performed.

From the illustration according to FIG. 2 it may be seen that also further mixers may be cascade-connected. By this it is possible to shift a signal having a current frequency, for example, to 27 center frequencies, if a three-stage mixer arrangement is realized, or to shift a signal having a current frequency to 81 center frequencies when a four-stage mixer arrangement is realized. Such a cascade may now be continued randomly, wherein a number of obtainable center frequencies is designated by the term 3^{x} and wherein x is the number of cascaded mixers.

Analog to the up-conversion in the transmitter, the down-conversion in the receiver is performed by a rotating complex pointer e^{j2πkf}^{_{c}}^{/f}^{ₛ}. Just like in the transmitter, thus for f_{c}=0 and ±fₛ/4 the down-conversion may be achieved by negating and multiplexing of the I and Q components. In this way, likewise three frequency sub-bands may be obtained. Analog to the cascading of mixer stages in the transmitter, again a cascading of mixers may take place like, for example, of the frequency converters shown in FIGS. 1A and 1B, whereby the number of frequency bands may be increased which may easily be separated numerically or in circuit engineering. Assuming, for example, the sampling frequency at the receiver input is equal to fₛ₂ and the center frequency of the received signal is f_{c}=f₀−f₂−f₁,
f_{c}=f₀−f₂+0,
f_{c}=f₀−f₂+f₁,
f_{c}=f₀−f₁,
f_{c}=f₀,
f_{c}=f₀+f₁,
f_{c}=f₀+f₂−f₁,
f_{c}=f₀+f₂,
or f_{c}=f₀+f₂+f₁. Altogether, nine frequency sub-bands may be separated. All of those center frequencies are converted by frequency conversion with 0 or ±fₛ₂/4=±f₂, respectively, to the center frequencies f_{c}=0 or f_{c}=±fₛ₁/4±f₁, respectively.

During the frequency conversion, in a frequency converter set up according to FIG. 1A or 1B simultaneously a downsampling from the (higher) sampling frequency fₛ₂ to the (lower) sampling frequency fₛ₁ may take place, wherein analog to the above-mentioned example the lower sampling frequency is fₛ₁=fₛ₂/4. Here, preferably the signal present at the high sampling frequency fₛ₂ is low-pass filtered in means for weighting in the frequency converter in order to mask out the resulting image frequencies in downsampling. Then, again a mixing with 0 or ±fₛ₁/4=±f₁ may take place, so that finally the signal is at the center frequency f₀. For example, the receive signal may be at a center frequency f_{c}=f₀+f₂−f₁, as it illustrated by the center frequency 210 in FIG. 2. By the first frequency converter, then a conversion which is inverse to the mixing 208 may take place, wherein the signal is then applied to a center frequency 206 of f_{c}=f₀−f₁. Simultaneously to the frequency conversion, in the frequency converter, as indicated above, again a downsampling may take place. The now downsampled signal at the center frequency 204 of f_{c}=f₀−f₁ may then be converted to the center frequency 202 of f_{c}=f₀ by a frequency converter corresponding to the second mixer in a mixing which is inverse to the mixing 204.

The receive signal with the high sampling frequency is thus converted from the sampling frequency to a quarter of the sampling frequency by the sample rate reduction in the frequency converter. If further a spectral conversion of the current frequency by a quarter of the high sampling frequency takes place, then after the sampling rate reduction an output signal of the first frequency converter results in which the center frequency, apart from the reduction to a quarter of the current frequency, depending on the offset direction of the spectral conversion, is reduced or increased by one sixteenth of the sampling frequency.

Analog to the above implementations, also more than nine frequency sub-bands (for example 27, 81 frequency sub-bands) may be received or separated in the above-described way, if a corresponding number of mixer stages or frequency converter stages, respectively, are cascaded.

In the following, the mathematical basics of the frequency shift easy to realize in terms of numerics or circuit engineering are to be explained in more detail. In the continuous range, a frequency shift is achieved by the application of the formula
f(t)*e^{jω}^{₀}^{t}
which corresponds to a frequency shift F(j(ω-ω₀)) in the positive direction. The conversion into the discrete time range is as follows:
f[n]*e^{jn2πfT}^{ₛ}.

In particular, the case of a frequency shift by fₛ/4 (which corresponds to a rotation by π/2) is regarded more closely.

If for f fₛ/4 is substituted in the above formula, wherein fₛ is the sampling frequency (i.e. the spectrum is shifted in the “positive” direction), using fₛ=1/Tₛ the following is obtained:
f[n]*e^{jn2π(1/(4T}^{ₛ}^{))T}^{ₛ}=f[n]*e^{jnπ/2}=y[n]

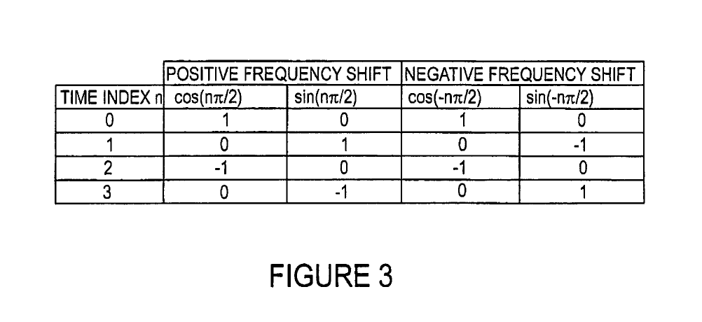

If for an input signal f[n]=i[n]+j*q[n] holds true, then using the Euler formula for the exponential expression (i.e. e^{jnπ/2}=cos(nπ/2)+j*sin(nπ/2)) terms for the real and imaginary part of y[n] are obtained
Re{y[n]}=i[n]* cos(nπ/2)−q[n]* sin(nπ/2)
Im{y[n]}=i[n]* sin(nπ/2)+q[n]* cos(nπ/2)
For a frequency shift in the positive direction (i.e. a frequency shift of the input signal toward a higher frequency of the output signal) the argument is positive, while in a frequency shift in the negative direction (i.e. a frequency of an input signal is higher than a frequency of the output signal) the argument of the sine and cosine function is negative. A tabular illustration of the value pairs of the terms cos(nπ/2) and sine(nπ/2) for different time index values n is illustrated in FIG. 3. Here, the above-mentioned terms for the sine and cosine function are respectively listed for a positive or negative frequency shift, wherein as a time index the values n=0, 1, 2 and 3 are used as a basis.

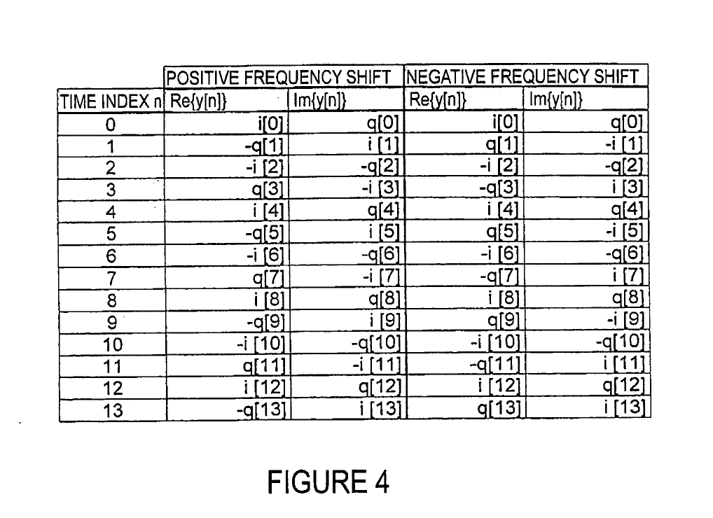

Based on the table illustrated in FIG. 3 and the above formula, a frequency shift of the input signal f[n] by fₛ/4 results for a complex input signal i[n]+j * q[n], as it is indicated in the tabular representation in FIG. 4. As it may be seen, the respective values for the real and imaginary parts of the positive and negative shifts for all odd indices are only different regarding their sign. Apart from that it is to be noted, that with all odd time indices the imaginary part value q[n] of the input signal f[n] is allocated to the real part value of the output signal y[n] either directly or in a negated form. Further, for each odd time index the real part value i[n] of an input signal f[n] is allocated to the imaginary part value of an output signal y[n] of the corresponding time index n either directly or in a negated form. The real and imaginary part values of the output signal y[n] of a mixer may thus be regarded as result values of a complex multiplication of an input value f[n] with a complex-value multiplication factor.

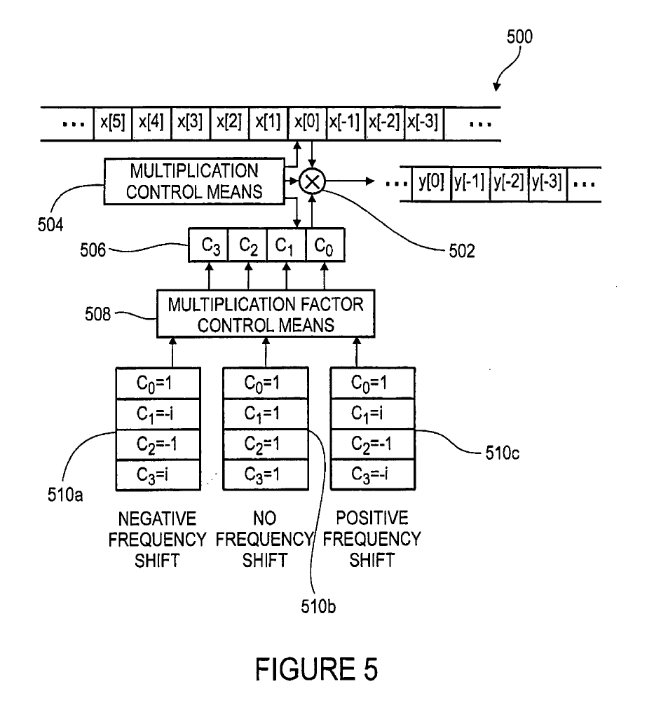

Such a multiplication may, for example, be achieved by a multiplication device 500 as it is illustrated in FIG. 5. Such a multiplication device 500 includes a multiplication element 502, a multiplication control means 504, a multiplication factor register 506 with several multiplication factors c₀, c₁, c₂ and c₃. A first multiplication factor set 510a (with the coefficients c₀=1, c₁=−i, c₂=−1, c₃=−i) corresponds to a negative frequency shift, a second multiplication factor set 510b (with the coefficients c₀=1, c₁=1, c₂=1, c₃=1) corresponds to a mixing in which no frequency shift takes place, while a third multiplication factor set 510c (with the coefficients c₀=1, c₁=i, c₂=−1, c₃=−i) corresponds to a mixing with a positive frequency shift. Further, input signals x[n], wherein n=−3, −2, −1, 0, 1, 2, 3, 4, 5, . . . , may be supplied to the mixer 500. As a result, the mixer 500 may output output values y[n], wherein n=−3, −2, −1, 0, . . . .

The functioning of the mixer 500 illustrated in FIG. 5 may now be described as follows. First, according to a desired frequency shift (for example using a control signal at the control input of the mixer 500 not illustrated in FIG. 5, using which the direction of the frequency shift may be set) one of the multiplication factor sets 510 is loaded into the multiplication factor register 506 for storing the used multiplication factor set with the help of the multiplication factor control means 508. If the mixer 500, for example, is to perform a positive frequency shift by a quarter of the sampling frequency, then the coefficient set 510c is loaded into the register 504. In order now to perform the frequency shift, an input value, for example the value x[0], is loaded into the multiplier 502 and is multiplied in the multiplier with the coefficient c₀=1, from which the result y[0] results. In a multiplication with the multiplication factor c₀=1 no negation or exchange of the real and imaginary parts of the complex signal input value x[0] results. This is also illustrated in the corresponding line of the table in FIG. 4, in which the real and imaginary parts in a positive frequency shift are shown for the time index 0 and show no change of the real or imaginary part.

As the next element, the subsequent input value x[1] is loaded into the multiplier 502 and multiplied with the multiplication factor c₁ (=i). From this, an output signal value results (i.e. a value y[1]), in which the real part of the input value is associated with the imaginary part of the output signal value and the imaginary part of the input value is negated and associated with the real part of the output value, as it is indicated in FIG. 4 in the line corresponding to the time index n=1 for a positive frequency shift.

Analog to this, in the multiplier 502 a multiplication of the next subsequent signal input value x[2] with the multiplication factor c₂ (=−1) and the again subsequent signal value x[3] with the multiplication factor c₃ (=−i) results. From this correspondingly the values indicated in FIG. 4 for the real and imaginary part of the corresponding output values y[n] result for n=2 and 3 according to the allocation in the column for a positive frequency shift.

The subsequent signal input values may be converted to corresponding signal output values y[n] by a cyclic repetition of the above-described multiplications using the multiplication factor stored in the register 506. In other words, it may thus be said that a positive frequency shift by a quarter of the sampling frequency which the input signal x is based on may be performed by a multiplication by a purely real or a purely imaginary multiplication factor, which, with a similar magnitude (e. g. a magnitude of 1) of the purely real or purely imaginary multiplication factors, again leads to the simplification that the multiplication may be performed merely by the exchange of real and imaginary part values and/or a negation of the corresponding values. Performing the multiplication itself is thus not necessary any more, and the result of the multiplication may rather be determined by those negation or exchange steps.

For a negative frequency shift, the use of the mixer 500 may be performed in an analog way, wherein now the multiplication factor set 510a is to be loaded into the register 506. In an analog way also a mixing may be performed, in which no frequency shift is performed when the multiplication factor set 510b is loaded into the register 506, as here only a signal input value x is multiplied with the neutral element of the multiplication (i.e. with a value 1), whereby the value of the input signal value x to the output signal value y does not change.

In the following, for reasons of clarity of the overall system, an upsampling and a frequency allocation is to be explained in more detail, as it is, for example, found in a transmitter. It is to be noted here as well, that the inventive concept mainly refers to the receiver, i.e. the down-converter. A description of the upsampling contributes to a better understanding of the overall system, however, and a more detailed description of the upsampling is thus enclosed here for this reason.

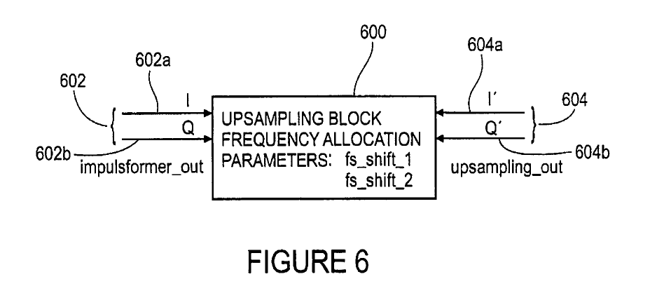

For describing the upsampling, the mixer may be illustrated as an upsampling block 600, as it is shown in FIG. 6. The upsampling block 600 here comprises an input interface 602, via which the upsampling block 600 receives complex input data present in the form of an I component 602a and a Q component 602b. This complex input data is, for example, output by an impulse former (not illustrated), which is why input data or the input data stream, respectively, is also designated in FIG. 6 by the term “impulseformer_out”. Further, the upsampling block 600 includes an output interface 604 for outputting the upsampled data, wherein the output interface 604 again includes a first component I′ 604a and a second component Q′ 604b. As the output data or the output data stream, respectively, is upsampled data, this data stream is also designated by “upsampling_out”. In order to enable a frequency allocation, i.e. a frequency shift of the center frequency of the data stream “impulseformer_out” to a center frequency of the data stream “upsampling_out”, in the upsampling block 600 the parameters fs_shift_1 and fs_shift_2 are used corresponding to the frequency f1 (=fs_shift_1) and f2 (=fs_shift_2) of FIG. 2.

Regarding the input data stream impulseformer_out it is further to be noted that the same, for example, comprises a word width of 8 bits per I or Q component, a data rate of B_Clock_16 (i.e. one sixteenth of the data rate of the output data stream), wherein the data type of the input data is to be regarded as complex-valued. It is further to be noted regarding the output data stream upsampling_out, that its word width, for example, includes 6 bits per I and Q component. Apart from that, the output data stream upsampling_out comprises a data rate of B_Clock defining the highest data rate or clock frequency, respectively, of the upsampling block 600 regarded here. Apart from that, the data type of the data of the output data stream upsampling_out is to be regarded as a complex data type.

From outside, only the two used frequency parameters fs_shift_1 and fs_shift_2 are transferred to the upsampling block 600. The same determine the conversion of the generated baseband signals (i.e. of the signals contained in the input data stream impulseformer_out) onto an intermediate frequency of [-B_Clock_16, 0, B_Clock_16], at a sampling rate of B_Clock_4 (parameter fs_shift_1) or a conversion to an intermediate frequency of [-B_Clock_4, 0, B_Clock_4] with a sampling rate of B_Clock (parameter fs_shift_2). The sampling rate B_Clock_4 here designates a quarter of the sampling rate or the sampling clock of B_Clock, respectively.

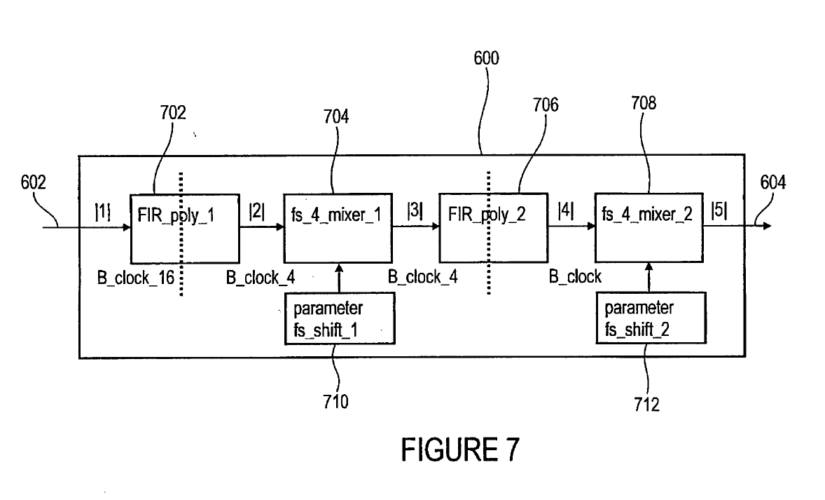

FIG. 7 shows a more detailed block diagram of the upsampling block 600 illustrated in FIG. 6. The upsampling block 600 may be designated as a mixer. The mixer 600 includes a first polyphase filter 702, a first mixer 704, a second polyphase filter 706, a second mixer 708, a first parameter set 710 and a second parameter set 712. The first polyphase filter 702 includes an input for receiving the input data stream impulseformer_out, equivalently designated by the reference numeral 602 or the reference numeral |1|. The input of the first polyphase filter (which is, for example, implemented as an FIR filter) is thus directly connected to the input 602 of the mixer 600. Further, the first polyphase filter is connected to the first mixer 704 via the port FIR_poly_1_out |2|. Further, the first mixer 704 is connected to an input of the second polyphase filter 706 via the port fs_4_mixer_1_out |3|. The second polyphase filter 706 further comprises an output connected to an input of the second mixer 708 via the port FIR_poly_2_out |4|. further, the second mixer 708 comprises an output connected to the output interface 604 of the mixer 600 via the port upsampling_out |5|. This port thus forms the output of the overall upsampling block 600 and is directly connected into the next higher hierarchy level. Further, the mixer 600 includes the first coefficient set 710 associated with the first mixer 704 and the second coefficient set 712 associated with the second mixer 708. The coefficients fs_shift_1 of the first coefficient set 710 and fs_shift_2 of the second coefficient set 712 are thus only correspondingly passed on to the two blocks fs_4_mixer_1 (i.e. the first mixer 704) or fs_4_mixer_2 (i.e. the second mixer 708), respectively. Further parameters are not contained in this embodiment of the mixer 600.

It is further to be noted that the data stream designated by the reference numeral |1| comprises data with a word width of for example 8 bits per I and Q component, wherein the data with a data rate of B_Clock_16 (i.e. a sixteenth of the clock B_Clock) are supplied to the first polyphase filter 702. Apart from that, the data supplied to the first polyphase filter comprise a complex-value data type. In the first polyphase filter 702 (which is preferably implemented as an FIR filter) an increase of the sampling clock is performed, for example, from B_Clock_16 to B_Clock_4, which corresponds to a quadruplication of the sampling clock. By this, the signal FIR_poly_1_out designated by the reference numeral |2| distinguishes itself by the fact that the word width is also 8 bits per component and the data type is also to be regarded as complex-valued, and that the data rate was now increased to B_Clock_4, i.e. to a quarter of the maximum clock B_Clock.

In the first mixer 704 using the parameter set 710 for the parameter fs_shift_1 a frequency conversion takes place, wherein a difference between a center frequency of the signal designated by the reference numeral |2| and a center frequency of the signal designated by the reference numeral |3| corresponds to a quarter of the sampling clock rate B_Clock_4. Thus, it may be noted that the signal with the reference numeral |3| was shifted to a higher intermediate frequency than the signal FIR_poly_1_out, wherein a word width of the signal fs_4_mixer_1_out is 8 bits per component, the data type is complex-valued and the data rate is B_Clock_4.

Further, in the second polyphase filter 706 (for example also including an FIR filter) a further upsampling is performed such that the signal FIR_poly_2_out designated by the reference numeral |4| comprises a sampling rate or data rate of B_Clock (i.e. the maximum achievable sampling rate in the mixer 600). The word width of the signal FIR_poly_2_out is here also 8 bits per I and Q component, while the data type of this signal is also complex-valued. Subsequently, by the second mixer 708, which is also a mixer with a frequency shift by a quarter of the supplied sampling frequency, a frequency conversion of the signal FIR_poly_2_out takes place, also designated by the reference numeral |4|, to the signal upsampling_out, also designated by the reference numeral |5|. Here, the parameter set 712 is used, for example, indicating a direction in which the frequency shift is to be performed. The signal upsampling_out may comprise a word width of 6 bits per I and Q component, for example predetermined by an external upsampling filter. The data rate of the signal upsampling_out is B_Clock, while the data type is again complex-valued.

In the following, the basic functioning of block FIR_poly_1 (i.e. of the first polyphase filter 702) and block FIR_poly_2 (i.e. of the second polyphase filter 706) is described in more detail. Each of those blocks, in the present embodiment, causes a quadruplication of the sampling rate with a simultaneous maintenance of the signal bandwidth. In order to upsample a signal by the factor 4, between each input sample three zeros are to be inserted (“zero insertion”). The now resulting “zero-inserted” sequence is sent through a low-pass filter in order to suppress the image spectrums at multiples of the input sampling rate. According to principle, here all used filters are real, i.e. comprise real-valued coefficients. The complex data to be filtered may thus always be sent through two parallel equal filters, in particular a division of a signal into an I component (i.e. a real part of the signal) and a Q component (i.e. an imaginary part of the signal), respectively only comprising real values, is in this case clearly simplified, as a multiplication of real-value input signals with real-value filter coefficients is numerically substantially more simple than multiplications of complex-valued input values with complex-valued filter coefficients.

Some known characteristics of the input signal or the spectrum to be filtered, respectively, may be used to further minimize the computational overhead. In particular, by a polyphase implementation and a use of the symmetry of sub-filters of the polyphase implementation, advantages may be used, as it is explained in more detail below.

A polyphase implementation may preferably be used, as the input sequence only comprises a value different from 0 at every fourth digit, as described above. If an FIR filter in a “tapped delay line” structure is assumed, then for the calculation of each output value only L/R coefficients are used (L=FIR filter length, R=upsampling factor). The used coefficients repeat periodically after exactly R output values. Thus, such an FIR filter may be divided into R sub-filters of the length L/R. The outputs of the corresponding filters then only have to be multiplexed in the correct order to a higher-rate data stream. Further, it is to be noted that a realization of the FIR filter, for example with the function “intfilt” of the software tool MATLAB, leads to a regular coefficient structure for the second sub-filter (i.e. the second sub-filter comprises an even length and an axial symmetry). Further it may be seen that the fourth sub-filter may approximately be reduced to one single delay element, as it is indicated in more detail below.

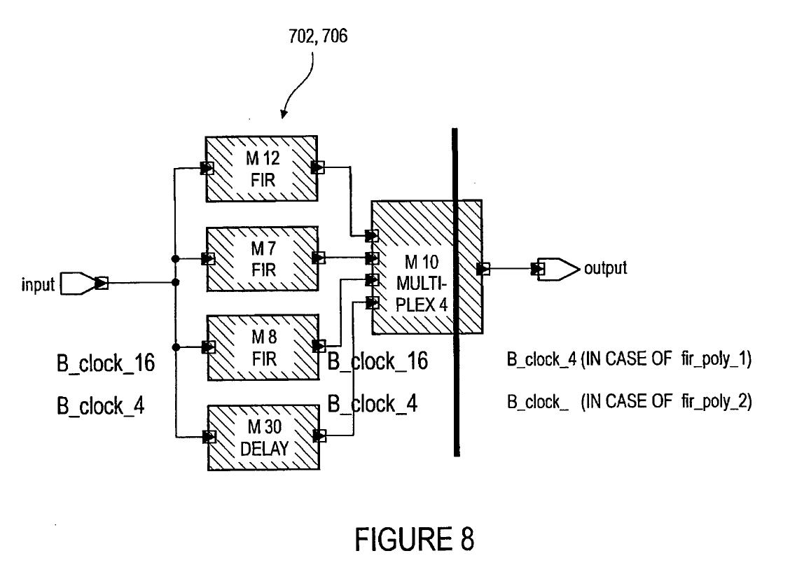

A block diagram of a concrete realization of a polyphase filter, like, for example, of the first polyphase filter 702 or of the second polyphase filter 706 is indicated as an example in FIG. 8. Such a polyphase filter includes an input, a first FIR filter M12, a second FIR filter M7, a third FIR filter M8, a delay element M30, a four-to-one multiplexer M10 and an output. The first FIR filter M12, the second FIR filter M7, the third FIR filter M8 and the delay element M30 respectively comprise an input and an output, wherein the input of each of the four mentioned elements is connected to the input of the polyphase filter. The four-to-one multiplexer M10 comprises four inputs and one output, wherein each of the four inputs is connected to one output of one of the FIR filters M12, M7, M8 or the output of the delay element M30. Further, the output of the four-to-one multiplexer M10 is connected to the output of the polyphase filter. An input data stream which is fed to the polyphase filter 702 or 706, respectively, via the input of the same, is thus put in parallel onto four FIR filters (i.e. after the reduction of the sub-filter 4 to one delay element only to the three FIR filters M12, M7 and M8) and is then again multiplexed by the four-to-one multiplexer M10. By this parallelization, a change of the port rates between the input of the polyphase filter and the output of the polyphase filter by the factor of 4 is achieved.

In a use of the structure illustrated in FIG. 8 for the first polyphase filter, i.e. the polyphase filter FIR_poly_1 illustrated in FIG. 7, this means an increase of the data rate from B_Clock_16 to B_Clock_4. For the case of using the figure illustrated in FIG. 8 for the second polyphase filter 706, i.e. the filter FIR_poly_2 illustrated in FIG. 7, this means a data rate increase from B_Clock_4 to B_Clock. It may further be noted that such a filter, in particular the filter coefficients, may for example be generated using the command coeff=intfilt (4, 6, ⅔) of the software tool MATLAB.

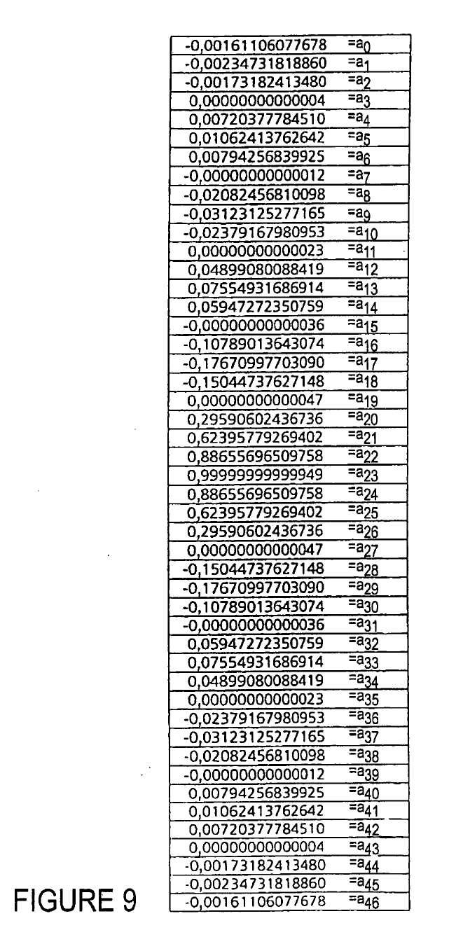

FIG. 9 shows a tabular representation of filter coefficients a₀ to a₄₆, as it may be obtained using the above-mentioned command with the software tool MATLAB. To the individual sub-filters, i.e. the first FIR filter M12, the second FIR filter M7, the third FIR filter M8 and the delay element, now different coefficients of the coefficient set of the filter coefficients a₀ to a₄₆ illustrated in FIG. 9 may be allocated. For example, the coefficients a₀, a₄, a₈, a₁₂, . . . may be allocated to the first FIR filter M12. This may again be performed using a MATLAB command coeff1=coeff(1:4:end). The coefficients a₁, a₅, a₉, a₁₃, . . . may be allocated to the second FIR filter M7, as it is, for example, possible using the MATLAB command coeff2=coeff(2:4:end). The coefficients a₂, a₆, a₁₀, 1₁₄, . . . may be allocated to the third FIR filter M8, as it is, for example, possible using the MATLAB command coeff3=coeff(3:4:end). The coefficients a₃, a₇, a₁₁, a₁₅, . . . may be allocated to the fourth FIR filter (which may, for the reasons described below, be reduced to a delay element), as it is, for example, possible using the MATLAB command coeff4=coeff(4:4:end).

As it may be seen from the tabular illustration in FIG. 9, the coefficients allocated to the fourth sub-filter approximately comprise the value 0, except for the coefficient a₂₃, approximately comprising the value of 1. For this reason, neglecting the coefficients approximately having the value 0, the fourth sub-filter may be changed to a delay structure, as the coefficient set of the fourth sub-filter coeff4 is occupied by a value of approximately 1 (see a₂₃) only at digit 6 (sixth element of the coefficient set in the MATLAB count). Thus, this block may be replaced by a delay element with delay=5, which corresponds to a shift of the input value by five elements. Further, the coefficient set coeff2, associated with the second sub-filter M7, comprises an axial-symmetrical structure and an even length, whereby this FIR filter may be shortened in order to at least halve the number of multiplications.

In the following, the setup of the first mixer 704 and of the second mixer 706 are described in more detail, corresponding to the blocks fs_4_mixer_1 and fs_4_mixer_2 illustrated in FIG. 7. In principle it may be noted that a mixer converts a signal up or down in the spectral range by a certain frequency. The shift is here always related to the sampling frequency. An fₛ/4 mixer, for example, shifts an input signal by exactly 25% of the sampling frequency and outputs this signal shifted in the frequency range as an output signal. A complex mixing, i.e. a mixing of a complex signal, is performed by a multiplication with a complex rotary term, which is:
dt[n]=exp [i*2*π*Δf/fₛ*n) wherein i=sqrt (−1).

With a frequency shift of Δf=fₛ/4, such an fₛ/4 mixer is reduced to a simple multiplier using the vector [1; i; −1; −i]. This was already illustrated as an example in FIG. 5. It may thus be said that the first, fifth, ninth, . . . input value is always multiplied by 1, while the second, sixth, tenth, . . . input value is always multiplied by i. The third, seventh, eleventh, . . . input value is then always multiplied by −1 and the fourth, eighth, twelfth, . . . input value is always multiplied by −i. Such a multiplication results in a positive frequency shift.

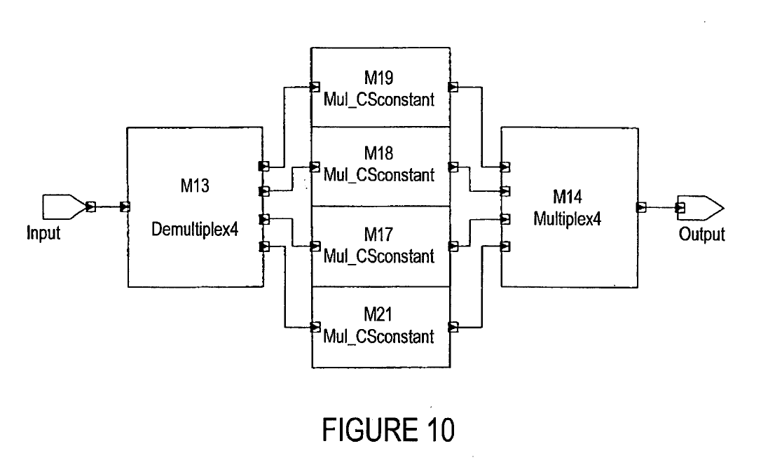

As it was indicated above, such an fₛ/4 mixing may be realized by four simple operations. Similar to a polyphase filter, such a mixer block, as it is illustrated in FIG. 7 as a first mixer 704 and a second mixer 708, may internally operate at a quarter of the output data rate. A mixer implemented in such a way is illustrated in FIG. 10. Such a mixer thus includes a mixer input, indicated as input, a one-to-four demultiplexer M13, a first multiplication element M19, a second multiplication element M18, a third multiplication element M17, a fourth multiplication element M21, a four-to-one multiplexer M14 and an output designated by output in FIG. 10.

The one-to-four demultiplexer M13 includes an input connected to input. Further, the one-to-four demultiplexer includes four outputs. The multiplication elements M19, M18, M17 and M21 respectively include one input and one output. One input each of one of the multiplication elements is connected to another output of the one-to-four demultiplexer M13. The four-to-one multiplexer M14 includes four inputs, wherein respectively one of the inputs of the four-to-one multiplexer M14 is connected to another output of one of the multiplication elements. Further the output of the four-to-one multiplexer M14 is connected to output.

If such a mixer illustrated in FIG. 10 receives a signal at its input, this signal is divided into block of four continuous signal values each, wherein one signal value each is allocated to another one of the multiplication elements M19, M18, M17 and M21. In those multiplication elements a multiplication explained in more detailed below takes place, wherein the result of the multiplication is supplied to the four-to-one multiplexer M14 via the outputs of the multiplication elements, generating a serial data stream from the supplied values and outputting the same via the output.

The values supplied to the mixer via its input are preferably complex data values, wherein to each of the multiplication elements M19, M18, M17 and M21 a complex data value is supplied through the one-to-four demultiplexer M13. For the multiplication, in each of the multiplication elements, subsequently a multiplication with a multiplication factor is performed, wherein the multiplication factor, for example, corresponds to the above-mentioned vector [1; i; −1; −i]. If, for example, in the first multiplication element M19 a multiplication with the first coefficient of the above-mentioned vector is performed (i.e. with a coefficient of 1) this means that directly at the output of the first multiplication element M19 the value applied at the input of the first multiplication element is output. If, for example, at the second multiplication element M18 a multiplication with the second coefficient (i.e. with i) is performed, this means that at the output of the second multiplication element M18 a value is applied corresponding to the following context:
output=−imag (input)+1*real (input),
wherein imag (input) designates the imaginary part of the input value and real (input) designates the real part of the input value.

If, for example, in the third multiplication element a multiplication with the third coefficient of the above-mentioned vector (i.e. with −1) is performed, this means that at the output of the third multiplication element M17 a value is applied which assumes the following context with regard to the value applied to the input:
output=−real (input)−i*imag (input).

If further in the fourth multiplication element M21 a multiplication using the fourth coefficient (i.e. using −1) as a multiplication factor is performed, this means that at the output of the fourth multiplication element M21 a value is output which, considering the value applied at the input of the fourth multiplication element, is in the following context:
output=imag (input)−i*real (input).

Depending on the default of the parameter value fs_shift_1 illustrated in FIG. 7, which is supplied to the first mixer, or the second parameter set 712 with the parameter value fs_shift_2 which is supplied to the second mixer 708, a special vector is selected indicating the individual constants. For the case that, for example, fs_shift_x (with x=1 or 2) is selected to be −1, i.e. that a negative frequency shift is to be performed, a vector is to be selected comprising the following coefficient sequence: [1, −i, −1, i].

For the case that the parameter fs_shift_x is selected to be 0, i.e. that no frequency shift is to take place in the mixer, a coefficient vector with a coefficient sequence of [1, 1, 1, 1] is to be selected, while for the case that the parameter fs_shift_x is selected to be 1 (i.e. that a positive frequency shift is to take place), a vector with a coefficient sequence of [1, i, −1, −i] is to be selected. From the above explanations it results that the first parameter set 710 and the second parameter set 712 may be selected different from each other, depending on which of the different target frequencies is to be achieved.

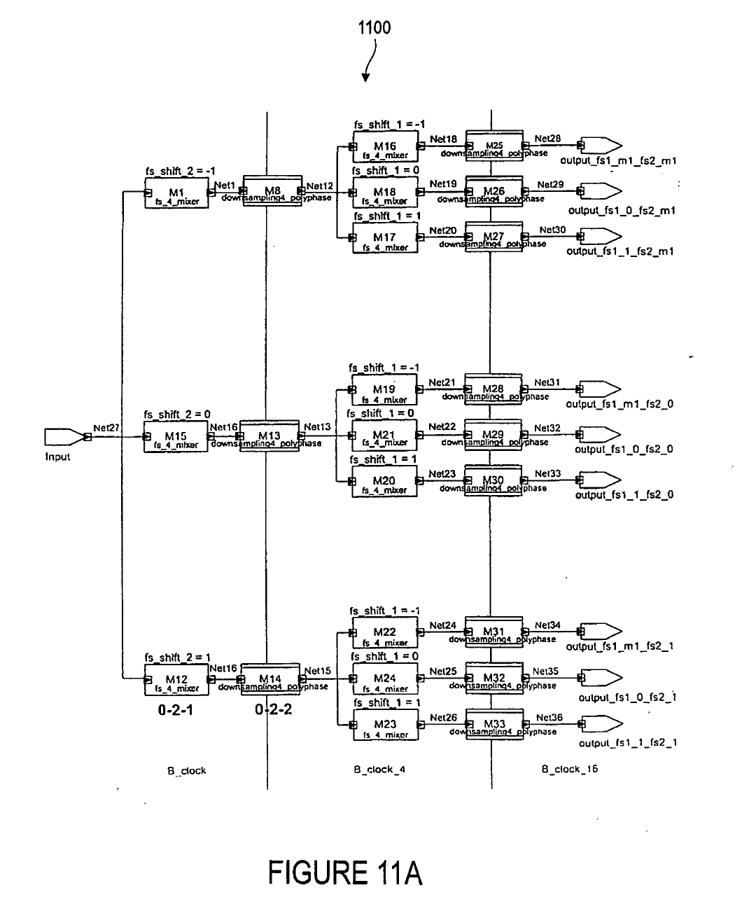

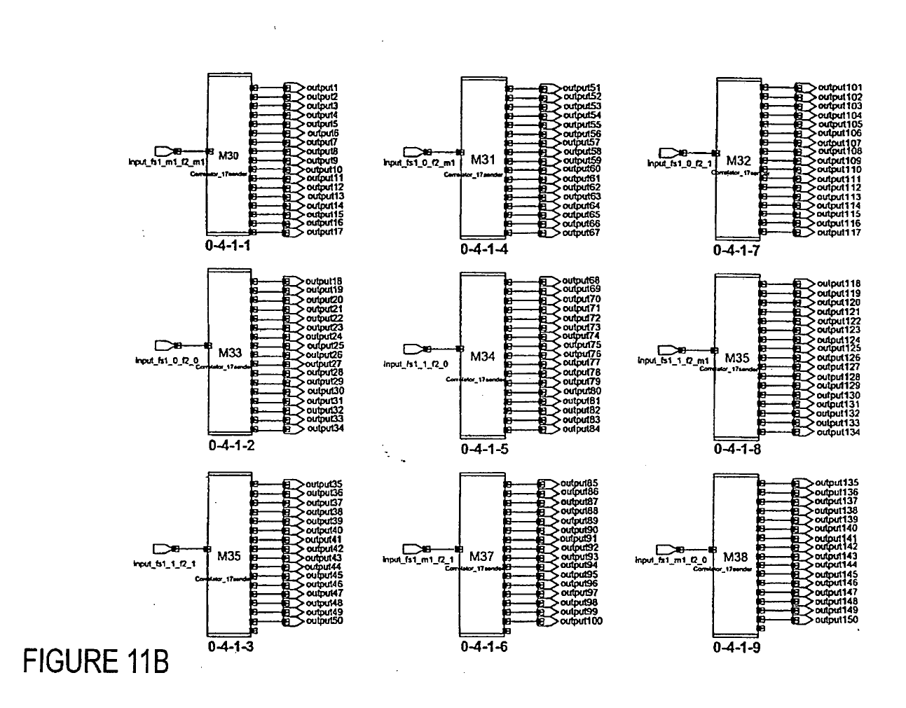

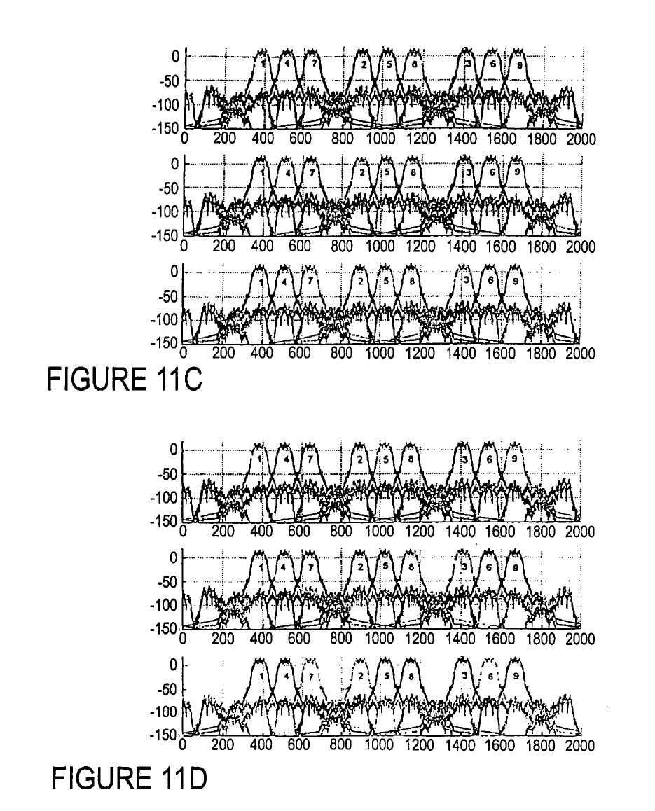

In the following, the downsampling is explained in more detail as it takes place, for example, in the frequency conversion in the receiver from a high current frequency to a low target frequency. Regarding this, FIG. 11A shows a block diagram of a mixer stage, as it may, for example, be used in a receiver. The mixer stage 1100 includes an input, a first mixer M1, a second mixer M15 and a third mixer M12, which are arranged in parallel in a first mixer level 0-2-1. Further, the mixer 1100 includes a first downsampling polyphase filter M8, a second downsampling polyphase filter M13, a third downsampling polyphase filter M14, a fourth mixer M16, a fifth mixer M18, a sixth mixer M17, a seventh mixer M19, an eighth mixer M21, a ninth mixer M20, a tenth mixer M22, an eleventh mixer M24 and a twelfth mixer M23. Additionally, the mixer 1100 further includes a fourth downsampling polyphase filter M25, a fifth downsampling polyphase filter M26, a sixth downsampling polyphase filter M27, a seventh downsampling polyphase filter M28, an eighth downsampling polyphase filter M29, a ninth downsampling polyphase filter M30, a tenth downsampling polyphase filter M31, an eleventh downsampling polyphase filter M32 and a twelfth downsampling polyphase filter M33.

Further, the mixer 1100 includes a first output output_fs1_m1_fs2_m1, a second output output_fs1_0_fs2_m1, a third output output_fs1_1_fs2_m1, a fourth output output_fs1_m1_fs2_0, a fifth output output_fs1_0_fs2_0, a sixth output output_fs1_1_fs2_0, a seventh output output_fs1_m1_fs2_1, an eighth output output_fs1_0_fs2_1, a ninth output output_fs1_1_fs2_1.

All components of the described mixer 1100 (except for the input and the outputs output_ . . . ) respectively include one input and one output. The input of the first mixer M1, the second mixer M15 and the third mixer M12 are connected to the input of the mixer 1100 via the signal Net27. The output of the first mixer M1 is connected to the input of the first downsampling polyphase filter M8 via the signal Net1. The output of the first polyphase filter M8 is connected to the inputs of the fourth mixer M16, the fifth mixer M18 and the sixth mixer M17 via the signal Net12. The output of the fourth mixer M16 is connected to the input of the fourth downsampling polyphase filter M25 via the signal Net18, while the output of the fourth downsampling polyphase filter M25 is connected to the first output of the mixer 1100 via the signal Net28. The output of the fifth mixer M18 is connected to the input of the fifth downsampling polyphase filter M26 via the signal Net19, while the output of the fifth downsampling polyphase filter M26 is connected to the second output of the mixer 1100 via the signal Net29. The output of the sixth mixer M17 is connected to the input of the sixth downsampling polyphase filter M27 via the signal Net20, while the output of the sixth downsampling polyphase filter M27 is connected to the third output of the mixer 1100 via the signal Net30.

The output of the second mixer is connected to the input of the second downsampling polyphase filter M13 via the signal Net16. The output of the second downsampling polyphase filter M13 is connected to the inputs of the seventh mixer M19, the eighth mixer M21 and the ninth mixer M20 via the signal Net13. The output of the seventh mixer M19 is connected to the input of the seventh downsampling polyphase filter M28 via the signal Net21, while the output of the seventh downsampling polyphase filter M28 is connected to the fourth output via the signal Net31. The output of the eighth mixer M21 is connected to the input of the eighth downsampling polyphase filter M29 via the signal Net22, while the output of the eighth downsampling polyphase filter M29 is connected to the fifth output via the signal Net32. The output of the ninth mixer M20 is connected to the input of the ninth downsampling polyphase filter M30 via the signal Net23, while the output of the ninth downsampling polyphase filter M30 is connected to the sixth output via the signal Net33.

The third mixer M12 is connected to the input of the third downsampling polyphase filter M14 via the signal Net16. The output of the third downsampling polyphase filter M14 is connected to the inputs of the tenth mixer M22, the eleventh mixer M24 and the twelfth mixer M23 via the signal Net15. The output of the tenth mixer M22 is connected to the tenth downsampling polyphase filter M31 via the signal Net24, while the output of the tenth downsampling polyphase filter M31 is connected to the seventh output via the signal Net34. The output of the eleventh mixer M24 is connected to the input of the eleventh downsampling polyphase filter M32 via the signal Net25, while the output of the eleventh downsampling polyphase filter M32 is connected to the eighth output via the signal Net35. The output of the twelfth mixer M23 is connected to the input of the twelfth downsampling polyphase filter M33 via the signal Net26, while the output of the twelfth downsampling polyphase filter M33 is connected to the ninth output via the signal Net36.

Further, the outputs of the mixer 1100 are connected to the following components:
output_fs1_m1_fs2_m1 to the output of the fourth downsampling polyphase filter M25
output_fs1_0_fs2_m1 to the output of the fifth downsampling polyphase filter M26
output_fs1_1_fs2_m1 to the output of the sixth downsampling polyphase filter M27
output_fs1_m1_fs2_0 to the output of the seventh downsampling polyphase filter M28
output_fs1_0_fs2_0 to the output of the eighth downsampling polyphase filter M29
output_fs1_1_fs2_0 to the output of the ninth downsampling polyphase filter M30
output_fs1_m1_fs2_1 to the output of the tenth downsampling polyphase filter M31
output_fs1_0_fs2_1 to the output of the eleventh downsampling polyphase filter M32
output_fs1_1_fs2_1 to the output of the twelfth downsampling polyphase filter M33.

Analog to the mixer illustrated in FIG. 7, in the mixer 1100 illustrated in FIG. 11A also three different clock frequencies are used. First, the signal received at the input is based on a sampling frequency of B_Clock, wherein the first mixer M1, the second mixer M15 and the third mixer M12 operate using the sampling frequency B_Clock. In the following, in level 0-2-2, i.e. through the first downsampling polyphase filter M8, the second downsampling polyphase filter M13 and the third downsampling polyphase filter M14 a sampling rate reduction to a new sampling rate of B_Clock_4 takes place, which corresponds to a quarter of the sampling rate B_Clock. This means that the fourth to twelfth mixer operates with a sampling rate of B_Clock_4. In the following, by the fourth to twelfth downsampling polyphase filter a further sampling rate reduction to a new sampling rate of B_Clock_16 is performed, i.e. again a quartering of the sampling rate used in the fourth to twelfth mixer, which corresponds to one sixteenth of the sampling frequency of the signal applied to the input.

By the mixer structure 1100 illustrated in FIG. 11A, thus from the signal received at the input of the mixer 1100 simultaneously nine frequency sub-bands may be extracted. To this end it is necessary that the three mixers of level 0-2-1 are respectively set to a different mixing performance, that, for example, the first mixer M1 is set to a downconversion (downward mixing), the second mixer M15 to a neutral frequency conversion (i.e. no frequency shift) and the third mixer M12 to an upconversion (upward mixing). Further, also those mixer operating with the sampling rate B_Clock_4 (i.e. in particular the fourth to twelfth mixer) should be grouped into three mixers, respectively, wherein each mixer group is respectively connected downstream to one of the downsampling polyphase filters of the structure level 0-2-2. Each of the three mixers of a mixer group (i.e. for example the fourth, fifth and sixth mixers) should again be set different from each other so that, for example, the fourth mixer may again perform a downconversion, the fifth mixer no frequency conversion and the sixth mixer an upconversion. For the group of the seventh to ninth mixer and the group of the tenth to twelfth mixer the same holds true.

By such a cascaded and also parallel-connected mixer arrangement, thus the nine frequency bands may be extracted simultaneously from the signal applied at the input of the mixer 1100, as it is, for example, illustrated in FIG. 2. An advantage of such a parallel and cascaded arrangement is in particular that, on the one hand, by a structure easy to be implemented regarding numerics or circuit engineering a plurality of frequency sub-bands may simultaneously be resolved or received, respectively.

If now the individual frequency sub-bands, as they are illustrated in FIG. 11A as output signals, are to be provided with data, then on the individual frequency bands also several signals of different bands may be transmitted if the same are suitably correlated with each other. Here, FIG. 11B shows 9 correlators 0-4-1-1 to 0-4-1-9, representing the corresponding output signals of the mixer 1100 illustrated in FIG. 11A. Here, the corresponding output signals output_fs1_m1_fs2_m1 to output_fs1_1_fs2_1 are to be regarded as input signals input_fs1_m1_fs2_m1 to input_fs1_m1_fs_0. Each of the correlators 0-4-1-1 to 0-4-1-9 has one input and 17 outputs, wherein each of the outputs outputs an output signal output1 to output150 which is different from the other output signals. By such a setup, for example, 150 reference sequences may be distributed by 150 transmitters to the nine available frequency bands. A distribution of the individual reference sequences of the transmitters on one frequency band may in this case be performed by a correlation, wherein the obtained 150 correlation signals may later be used, for example, to coarsely determine the positions of 150 tracking bursts.

If only one frequency band existed, in which the 150 transmitters are located, 150 different reference sequences would be required for a possibility of distinguishing the individual transmitters. As the transmitters are distributed to 9 different frequency bands, theoretically only ┌150/9┐=17 sequences would be required, wherein 6 frequency bands respectively include 17 transmitters and 3 frequency bands (occupied by the correlators 0-4-1-3, 0-4-1-6 and 0-4-1-9) only respectively include 16 transmitters.

Assuming that the frequency bands have the same reference sequences for their 17 or 16 transmitters, respectively, in a simulation of such a transmission scenario the following problem occurs:

Two acquisition bursts were sent without mutually overlapping and without noise, wherein the two acquisition bursts were located in two different frequency bands but had the same reference sequences. With a particular selection of the two frequency bands, in the correlation with a sequence erroneously also peaks of the second burst sent were detected. These are exactly those frequency bands wherein one of the two rotation parameters fs_shift_1 or fs_shift_2 matches, as in those cases the image spectrum of a frequency band is not sufficiently suppressed in the areas of the other associated frequency bands.

There are two possibilities to respectively merge three frequency bands having no common rotation parameter and for which thus the same sequences may be used without a false detection occurring (see FIG. 11C and FIG. 11D).

I.e., instead of 17 sequences 150/3=50 sequences are required.

The same sequences may be given to the following sequence triples:
1 (fs_shift_1=−1, fs_shift_2=−1), 6 (fs_shift_1=0, fs_shift_2=1), 8 (fs_shift_1=1, fs_shift_2=0) (see FIG. 11C topmost sub-diagram) or
2 (fs_shift_1=−1, fs_shift_2=0), 4 (fs_shift_1=fs_shift_1=0, fs_shift_2=−1), 9 (fs_shift_1=1, fs_shift_2=1) (see FIG. 11C middle sub-diagram) or
3 (fs_shift_1=−1, fs_shift_2=1), 5 (fs_shift_1=0, fs_shift_2=0), 7 (fs_shift_1=−1, fs_shift_2=−1) (see FIG. 11C bottommost sub-diagram)
   or alternatively the same sequences may be given to the following frequency triples:
1(fs_shift_1=−1, fs_shift_2=−1), 5 (fs_shift_1=0, fs_shift_2=0), 9 fs_shift_1=1, fs_shift_2=1) (see FIG. 11D topmost sub-diagram) or
3(fs_shift_1=−1, fs_shift_2=1), 4 (fs_shift_1=0, fs_shift_2=−1), 8 (fs_shift_1=1, fs_shift_2=0) (see FIG. 11D middle sub-diagram) or
2(fs_shift_1=−1, fs_shift_2=0), 6 (fs_shift_1 0, fs_shift_2=1), 7 (fs_shift_1=−1, fs_shift_2=−1) (see FIG. 11D bottommost sub-diagram).
The two FIGS. 11C and 11D this way show two possibilities to respectively occupy three frequencies with the same sequences. In the correlators of FIG. 11B the second possibility was selected, so that the same correlation sequences are used in blocks 0-4-1-1 to 0-4-1-3 or in blocks 0-4-1-4 to 0-4-1-6, or in the blocks 0-4-1-7 to 0-4-1-9, respectively. With the exception of the input signals in the different correlation sequences, the setup of blocks 0-4-1-1 to 0-4-1-9 is identical. As the correlation is performed after the matched filter, the correlation sequences in the binary case only have the coefficients of 1 and −1. For the quaternary case, the coefficients are 1+j, −1+j, 1−j and −1−j. In both cases, the correlation sequences thus have to be in the sampling clock B_clock_48.

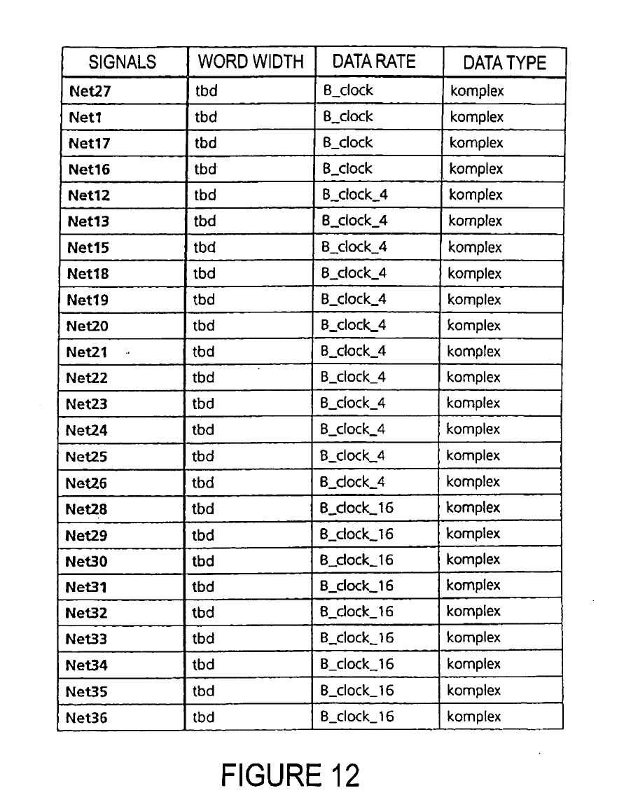

FIG. 12 shows a tabular illustration of the word width, data rate and data type of the signals illustrated in FIG. 11A, wherein it is to be noted that the word width of the corresponding signals may be defined depending on the used hardware components (tbd=to be defined). For the signal values of all signals, a complex data type is assumed.

First, a signal received from the mixer 1100 with a sampling clock B_clock is correspondingly down-converted by a quarter of the sampling frequency fₛ, is not frequency converted, or is up-converted by a quarter of the sampling frequency fs, using the parameter fs_shift_2 (i.e. with the parameter values fs_shift_2=−1, 0, 1), whereby three different signals are obtained. A more accurate definition of the parameter fs_shift_2 was discussed above. From the signal Net1 thus, as shown in the block diagram of FIG. 11A, the input signal Net27 is mixed with fs_shift_2=−1, the signal Net 17 is mixed with fs_shift_2=0 and the signal Net16 is mixed with fs_shift_2=1. Those three signals are then low-pass-filtered separately and downsampled, whereby three signals having a sample clock B_clock_4 are obtained.

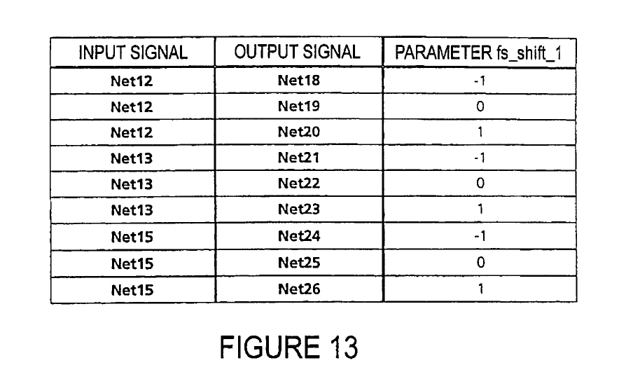

Subsequently, those signals are each frequency-converted again using the parameter fs_shift_1 (i.e. the parameter values fs_shift_1=−1, 0, 1), wherein now the offset of the converted frequency corresponds to a quarter of the new sampling frequency (in the positive and negative direction) or is equal to 0. The input signals Net12, Net13 and Net15 are here mixed according to the table in FIG. 13 with the parameter fs_shift_1 in order to obtain the output signals Net18, Net19, Net20, Net21, Net22, Net23, Net24, Net25 and Net26. Finally, the nine resulting signals are low-pass filtered and downsampled and thus fed out at a sample clock of B_clock_16 via the first to ninth output.

In the following, again briefly the functioning of the mixers is explained, taking the mixers in level 0-2-1 and the downsampling polyphase filters as an example, using the downsampling polyphase filters of level 0-2-2 illustrated in FIG. 11A. The mixers in level 0-2-1 cancel out the shifting of the respectively applied signal by exactly 25% of its sampling frequency that took place in the transmitter. The complex mixing is again performed by a multiplication with a complex rotary term, which is:
dt[n]=exp [j*2*π*Δf/fₛ*n) wherein j=sqrt (−1).

With a mixer Δf=−fₛ/4 this vector is reduced to [1; −j; −1; j]. This means that the first, fifth, ninth, . . . input values are always multiplied by −1, the second, sixth, tenth, . . . inputs values are always multiplied by −j, the third, seventh, eleventh, . . . input values are always multiplied by −1 and the fourth, eighth, twelfth, . . . input values are always multiplied by j. As it may be seen from the above description, this −fₛ/4 mixing may be realized by four simple operations. Similar to a polyphase filter, this block may operate internally at a quarter of the output data rate. The setup and the function of such an fₛ/4 mixer has already been described in more detail in FIG. 10 and in the description corresponding to the same.

Such a mixer described there may also be used for a mixing in the receiver when the parameters fs_shift_1 and fs_shift_2 and the conversion of the sampling rate are selected suitably.

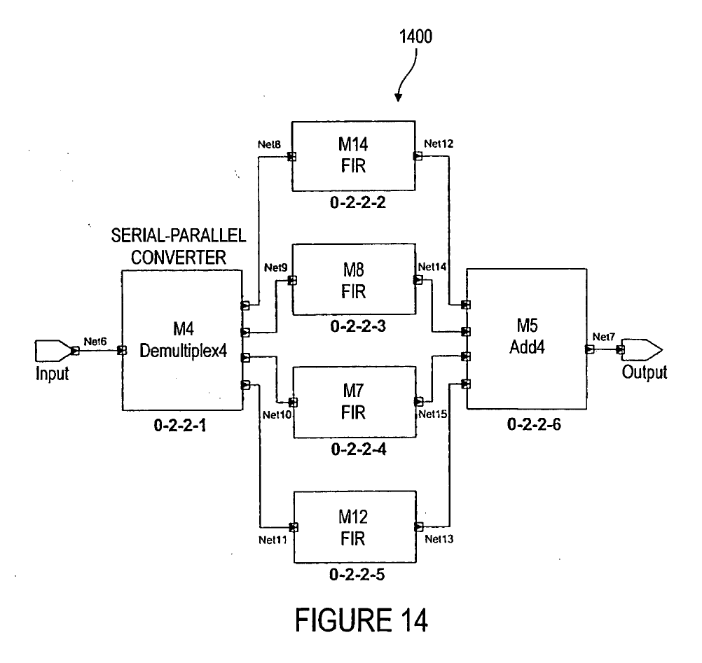

In the following paragraph, the concrete conversion of the downsampling polyphase filters in level 0-2-2 illustrated in FIG. 11A is explained in more detail. With these downsampling polyphase filters in level 0-2-2, first a downsmapling of the signal to clock B_clock_4 and after a second −fₛ/4 mixing a downsampling to clock B_clock_16 is achieved. With the downsampling operations by the factor 4 present in this embodiment, the respectively applied signal is filtered with a low pass in order to suppress the occurring image spectrums and then only pass on every fourth sample. Basically, the setup of a downsampling polyphase filter corresponds to the setup of a polyphase filter illustrated in FIG. 8, in which an upsampling is performed; here, some details are to be explained in more detail. For this purpose, in FIG. 14 a block diagram of an exemplary structure of a downsampling polyphase filter is illustrated, as it may be used in level 0-2-2 illustrated in FIG. 11A.

FIG. 14 thus shows a downsampling polyphase filter 1400 comprising an input, a one-to-four demultiplexer 0-2-2-1 (serial parallel converter), a first FIR filter 0-2-2-2, a second FIR filter 0-2-2-3, a third FIR filter 0-2-2-4, a fourth FIR filter 0-2-2-5, an adder 0-2-2-6 and an output. Each of the FIR filters 0-2-2-2 to 0-2-2-5 respectively includes one input and one output. An input of the one-to-four demultiplexer 0-2-2-1 is connected to the input of the downsampling polyphase filter 1400 via the signal Net6. A first output of the demultiplexer M4 is connected to the input of the first FIR filter M14 via the signal Net8. A second output of the demultiplexer M4 is connected to the second FIR filter M8 via the signal Net9. A third output of the demultiplexer M4 is connected to the third FIR filter M7 via the signal Net10 and a fourth output of the demultiplexer M4 is connected to the input of the fourth FIR filter M12 via the signal Net11. Further, a first input of the adder M5 is connected to the output of the first FIR filter M14 via the signal Net12, a second input of the adder M5 is connected to the second FIR filter M8 via the signal Net14, a third input of the adder M5 is connected to the output of the third FIR filter M7 and a fourth input of the adder M5 is connected to the output of the fourth FIR filter M12 via the signal Net13. Additionally, an output of the adder M5 is connected to the output of the downsampling polyphase filter 1400 via the signal Net7.

As it may be seen from FIG. 14, a low-pass filter required in level 0-2-2 may be realized with the help of a polyphase approach, as an FIR filter having the length L may be divided into R sub-filters of the length L/R, wherein L indicates the FIR filter length and R indicates the upsampling factor of a signal. By this, by the downsampling polyphase filter 1400 two functionalities are performed: the mixer function and the downsampling function. To this end, the signal supplied to the downsampling polyphase filter 1400 via its input is divided into R=4 parallel signal streams in the demultiplexer M4, and thus the applied sample clock is quartered (i.e. for example brought from a sample clock of B_clock to B_clock_4 or from B_clock_r to B_clock_16, respectively). The individual signal streams (i.e. the signals Net8-Net11) are then respectively filtered using an FIR filter of the length L/4 and the results are transmitted to the adder M5 via the signals Net12-Net15. In the adder M5 a summation of the signal values of the signals Net12-Net15 takes place.

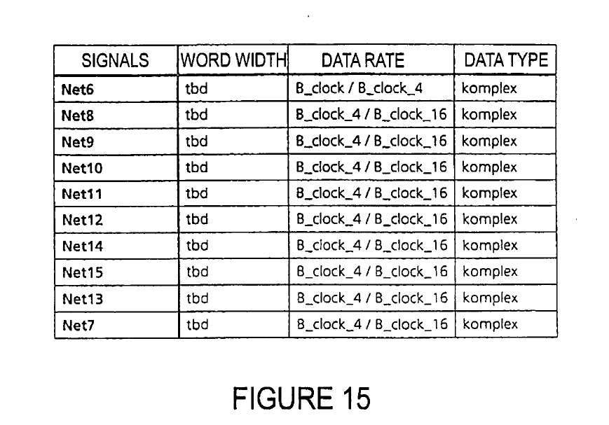

A word width, a data rate and a data type of the signals illustrated in FIG. 14 may be taken from the tabular illustration of FIG. 15. Here, it is to be noted that a word width depends on the used hardware components (in particular a word width of an analog/digital converter used at the front end of the receiver). For this reason it may be said, that the word width is still to be defined depending on the use of the hardware components (i.e. in the column “word width” the designation tbd is inserted). Regarding the data rate it may be said, that the downsampling polyphase filter illustrated in FIG. 14 cancels out a signal conversion caused by the filter illustrated in FIG. 8, whereby the reduction of the sampling rate of the signal Net6 with regard to the sampling rates of the signals Net7-Net15 may be explained. With regard to the data type it is to be noted that each of the illustrated signals is to be regarded as a complex signal.

Regarding the selection of the filter coefficients for the individual filters (i.e. the first FIR filter M14, the second FIR filter M8, the third FIR filter M7 and the fourth FIR filter M12) reference is made to the implementations regarding the filter illustrated in FIG. 8, wherein in particular the filter coefficients may be selected according to the tabular illustration in FIG. 9. Further, the fourth FIR filter M12, for the above-mentioned reasons, may again be selected as a delay element with a delay of 5 samples (i.e. the fourth FIR filter M12 may be implemented such that only a shift of the received input value by five elements takes place). Further, the second FIR filter M8 may be shortened based on the axially symmetrical structure and the even filter length, in order to at least halve the number of multiplications.

In the next section, a further embodiment of the inventive approach of the reduction of the sampling rates (i.e. the down-conversion) is to be explained in more detail. To this end, as an example a sampling rate reduction by the rate factor 4 and a filtering using an FIR filter having six coefficients (a₀, a₁, a₂, a₃, a₄ and a₅) is selected. As an input sequence, the signal value sequence x₉, x₈, x₇, x₆, x₅, x_{4,} x₃, x_{2,} x₁ and x₀ is used, wherein x₀ is the first received signal or the first sample.

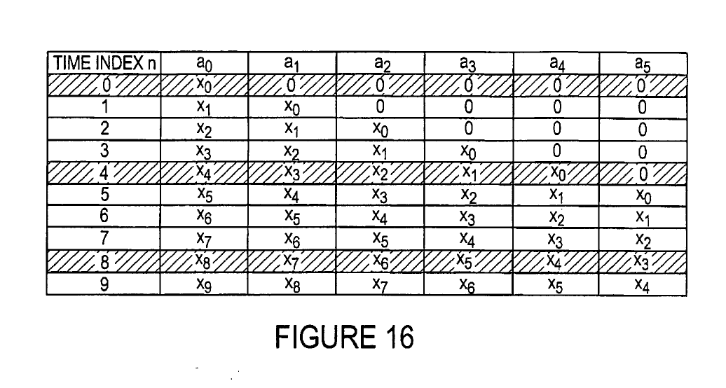

In FIG. 16, the temporal allocation of the input data x to the filter coefficients when using the FIR filter with six coefficients is illustrated. The filter output here, according to the FIR filter regulation, results in an output value FIR_out=a₀*x₅+a₁*x₄+a₂*x₃+a₃*x₂+a₂ +. . . . In the case of the assumed sampling rate reduction factor of R) 4, only the value pairs with a dark background in the tabular illustration of FIG. 16 are used after the sampling rate reduction, all others are discarded.

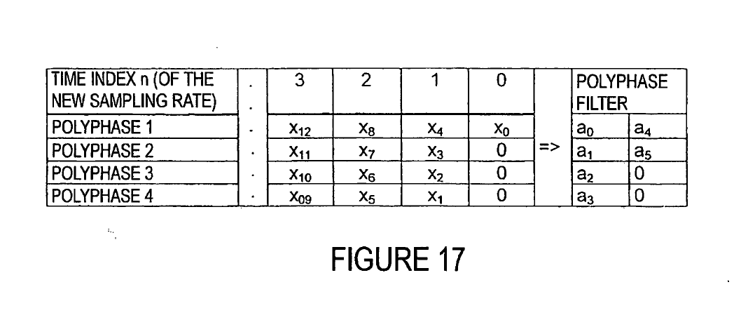

If the lines with a dark background are extracted, then another illustration of the linking of the input values and the filter coefficients may be shown. Such an illustration is given in FIG. 17. The two right columns, i.e. the columns in which the filter coefficients a₀-a₅ are entered, now contain the coefficients in a different arrangement. The typical structures with FIR filters result, which are implemented in a polyphase structure. Each of the individual polyphases (“SUB FIR filter”) consists of the coefficients of the original filter. The allocation is here performed according to the following scheme:

polyphase “1”: a_{0+i*rate factor}

polyphase “2”: a_{1+i*rate factor}

polyphase “3”: a_{2+i*rate factor}

. . .

polyphase “rate factor”: a_{(rate factor-1)+}1*rate factor

wherein i=0, 1, . . .

In the above example, with a rate factor of R=4, this means the allocation of the filter coefficients a₀ and a₄ to polyphase 1, the filter coefficients a₁ and a₅ to polyphase 2, the filter coefficients a₂ and the value 0 to polyphase 3 and the filter coefficients a₃ and the value 0 to polyphase 4. Should the number of the coefficients of the FIR filter not be dividable by the integer rate factor, then the missing coefficients are replaced by the value 0, as it was performed with the polyphases 3 and 4.

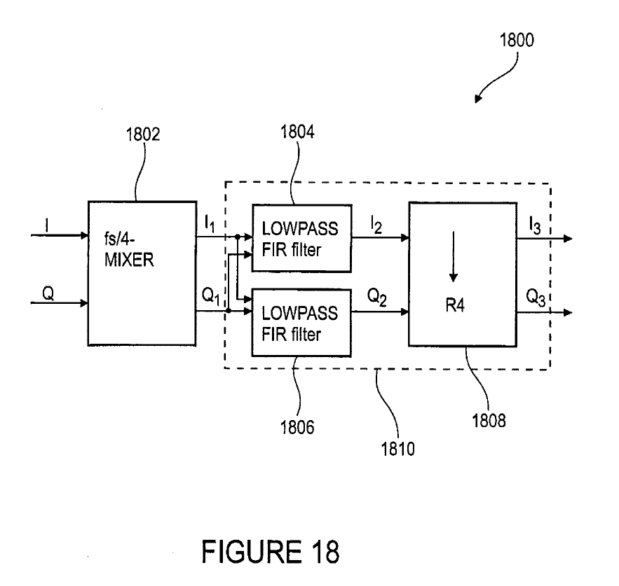

Such a polyphase filter structure may now effectively be used for a frequency shift by a quarter of the sampling frequency with a subsequent sampling rate reduction. FIG. 18 shows a block diagram of a mixer 1800, in which the principal functioning of the frequency shift of a complex signal with a subsequent sampling rate reduction by the factor R=4 is illustrated. The mixer 1800 includes an fₛ/4 mixer 1802, a first low-pass filter 1804, a second low-pass filter 1806 and a sampling rate reduction unit 1808. The fₛ/4 mixer 1802 includes a first input I for receiving an I component of a signal and a second input Q for receiving a Q component of a signal, wherein the Q component of the signal is orthogonal to the I component of the signal. Further, the fₛ/4 mixer 1802 includes a first output for outputting an I₁ component of a mixed signal and a second output for outputting a Q₁ component of the mixed signal.

Further, the first low-pass filter 1804 comprises an input for receiving the I₁ component of the frequency-converted signal and an output for outputting an I₂ component of a low-pass-filtered frequency-converted signal. The second low-pass filter 1806 includes an input for receiving the I₁ component of the frequency-converted signal and an output for outputting a Q₂ component of a low-pass-filtered mixed signal. The sampling rate reduction unit 1808 includes a first input for receiving the I₂ component of the low-pass-filtered mixed signal and a second input for receiving the Q₂ component of the low-pass-filtered mixed signal. Further, the sampling rate reduction means 1808 includes a first output for outputting an I₃ component of a sampling-rate-reduced low-pass-filtered mixed signal and a second output for outputting a Q₃ component of a sampling-rate-reduced low-pass-filtered mixed signal.

The functioning of the mixer 1800 illustrated in FIG. 18 is described in more detail in the following. The following implementations here first relate to a polyphase filter realizing a functionality of block 1810 illustrated in FIG. 18. Here, by the polyphase filters to be realized, the functionality of the first low-pass filter 1804, the functionality of the second low-pass filter 1806 and the functionality of the sampling rate reduction means 1808 are to be provided. The two illustrated low-pass filters are here assumed to be identical.

If the values illustrated in FIG. 17 are used as (complex) input data x (=i+jq) for the mixer 1802 (i.e. the I component and the Q component), for example with a polyphase structure of the first low-pass filter 1804 an allocation of the real (i) and imaginary part values (q) of the input values illustrated in FIG. 17 according to the illustration in FIG. 19 results. The allocation of the real and imaginary part values i and q resulting from the input signal x to the frequency-converted signal with the components I₁ and Q₁ is done by the mixer 1802 which may perform a negation and/or exchange of real and imaginary part values of the input signal x to the frequency-converted signal I₁ and Q₁. It is further to be noted that the values illustrated in the table in FIG. 19 correspond to real part values, as they are listed in the tabular illustration in FIG. 4 for a positive frequency shift. The tabular illustration according to FIG. 19 thus represents the allocation of values to four different polyphases, if the first low-pass filter 1804 is implemented in a four-fold polyphase structure. The illustration in FIG. 19 thus shows how the real part with a polyphase structure of a signal shifted by fₛ/4 may be calculated as an input signal. Here, the real or imaginary part values, respectively, weighted with the corresponding filter coefficients a₀ to a₅ of the individual polyphase part filters (polyphase 1 to polyphase 4) are summed up in order to obtain the filtered and downsampled output signal I₃.

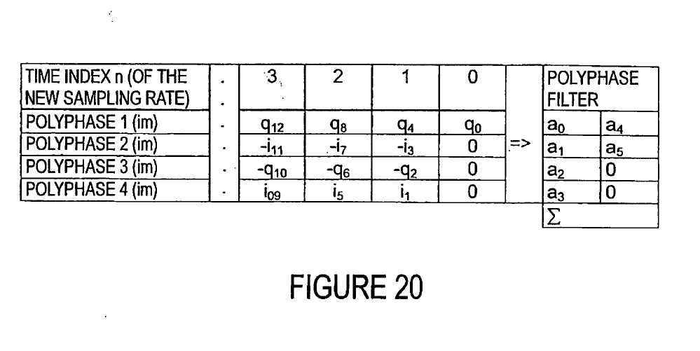

If, analog to the above implementations, for the second low-pass filter 1806 also a polyphase structure is used, like the complex input data x illustrated in FIG. 17 with a real part i and an imaginary part q, then as a result an allocation of the real and imaginary parts of the individual samples x to the polyphases results according to the illustration in FIG. 20. Here it is shown that the values illustrated in FIG. 20 correspond to the real part values of the overview illustrated in FIG. 4 with a positive frequency shift. Further, the real or imaginary part values, respectively, weighted with the corresponding filter coefficients a₀ to a₅ of the individual polyphase sub-filters (polyphase 1 to polyphase 4) are summed up in order to obtain the filtered and downsampled output signal Q₃.

With a close view of the respective input data x of the filters, as they are obvious by the i and q values from the tables in FIGS. 19 and 20, it is obvious that at every point in time, i.e. at every time index n, the polyphases are “fed” only with i or with q data. Due to the independence of the individual polyphases, the same may be resorted. For a calculation of the real part and the imaginary part of the mixer 1800 illustrated in FIG. 18, then only the corresponding polyphase results have to be summed. By such an implementation, thus a low-pass filtering and a downsampling may be performed, by filtering the input values with the filter coefficients of the (low-pass) filter a₀ to a₅ and simultaneously performing the downsampling by the summation of the four polyphase results to form a final result.

According to the mixer 1800 illustrated in FIG. 18, thus by the use of two polyphase filters respectively including the functionality of the first low-pass filter and the sampler or the functionality of the second low-pass filter 1806 and the sampling rate converter 1808, a clear simplification of the circuit structure may be realized. Thus, for example, the I₃ component, as it is illustrated in FIG. 18, may be realized from the summation of the individual results of the individual polyphases according to the illustration in FIG. 19, and the Q₃ component of the mixer 1800 illustrated in FIG. 18 may be realized by a summation of the partial results of the individual polyphases according to the summation in FIG. 20.

For repeated reference, it is to be noted here, that the signs of the input data x come from the upstream mixer. In FIG. 18, the data stream, consisting of the I₁ and the Q₁ components would thus have to be used as an input signal x for the low-pass filters. This in particular relates to the signs of the polyphases illustrated in FIGS. 19 and 20, polyphase 2 (im), polyphase 3 (re), polyphase 3 (im) and polyphase 4 (re). If the mixer is not present, the signs are omitted, or another frequency shift is selected, respectively, the signs in lines polyphase 2 (im) and polyphase 4 (im), and polyphase 2 (re) and polyphase 4 (re) are exchanged. Those signs may be included in the corresponding polyphases themselves. This is in particular interesting when always one of the two frequency shifts is selected, i.e. when the corresponding coefficients are negated.

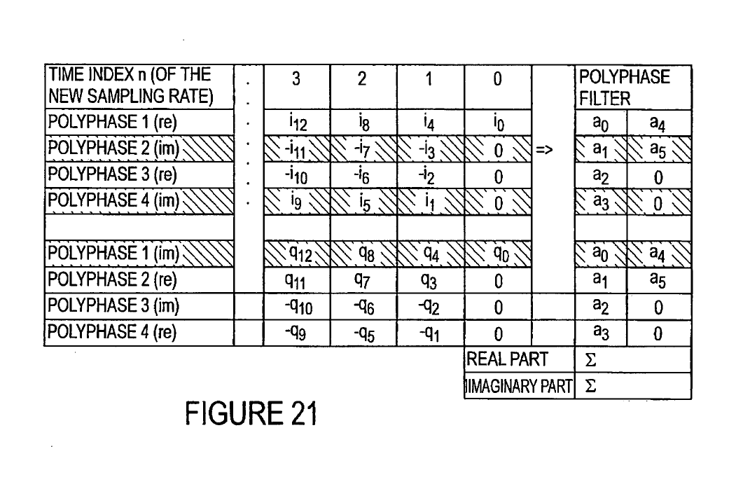

FIG. 21 shows such a negation of individual real part values i and imaginary part values q of the input signal values x, wherein simultaneously a reordering of the real and imaginary part values to individual polyphases of the different polyphase filter (i.e. the polyphase filter for the real part and the polyphase filter for the imaginary part) is performed. In the following, the polyphases of the FIR filter are designated by POLY_FIR_1, . . . , wherein the result of the first polyphase, i.e. of POLY_FIR_1 results as the sum of the input values weighted with the filter coefficients a₀ and a₄. For the second to fourth polyphase the above implementations also hold true. The outputs of the polyphase filters are designated by RE/IMAG_P_OUT_1 . . . 4. The inputs of the filters are represented by the real and imaginary part.

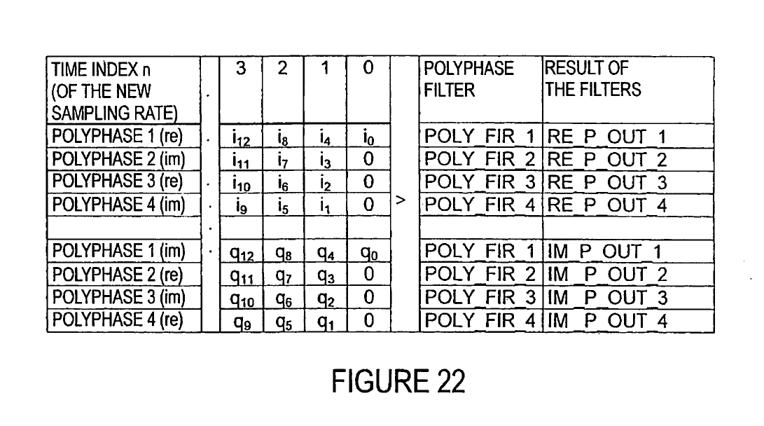

A general approach of the polyphase structure under consideration of an fₛ/4 shift is shown in FIG. 22. Here again an allocation of the real and imaginary part values to the individual polyphases is illustrated. Further, the designation of the results of the individual polyphases by RE_P_OUT_1 . . . 4 and IM_P_OUT_1 . . . 4 is defined. On the basis of the results defined in FIG. 22 of the polyphase filters now three possibilities may regarded:
no frequency shift;
frequency shift in the positive direction; and
frequency shift in the negative direction.

If no frequency shift is performed, a real part of the resulting (downsampled) signal which is, for example, the I₃ component of the mixer 1800 illustrated in FIG. 18, results by a summation of the results of the polyphases RE_P_OUT_1, RE_P_OUT_2, RE_P_OUT_3 and RE_P_OUT_4. Correspondingly, an imaginary part of the (downsampled) signal, for example corresponding to the Q₃ component of the mixer 1800 illustrated in FIG. 18, results by a summation of the results IM_P OUT_1, IM_P_OUT_2, IM_P_OUT_3, IM_P_OUT_4.

If a frequency shift in the positive direction is selected, the real part (i.e. of the I₃ component) may be determined by a summation of the polyphase results RE_P_OUT_1, IM_P_OUT_2, -RE_P_OUT_3 and -IM_P_OUT_4, while the imaginary part (i.e. the Q₃ component) results from a summation of the polyphase results IM_P_OUT_1, -RE_P_OUT_2, -IM_P_OUT_3 and RE_P_OUT_4. If a frequency shift in the negative direction is desired, the real part may be determined by a summation of the polyphase results RE_P_OUT_1, -IM_P_OUT_2, -RE_P_OUT_3 and IM_P_OUT_4, whereas the imaginary part may be determined by a summation of the polyphase results IM_P_OUT_1, RE_P_OUT_2, -IM_P_OUT_3 and -RE_P_OUT_4.

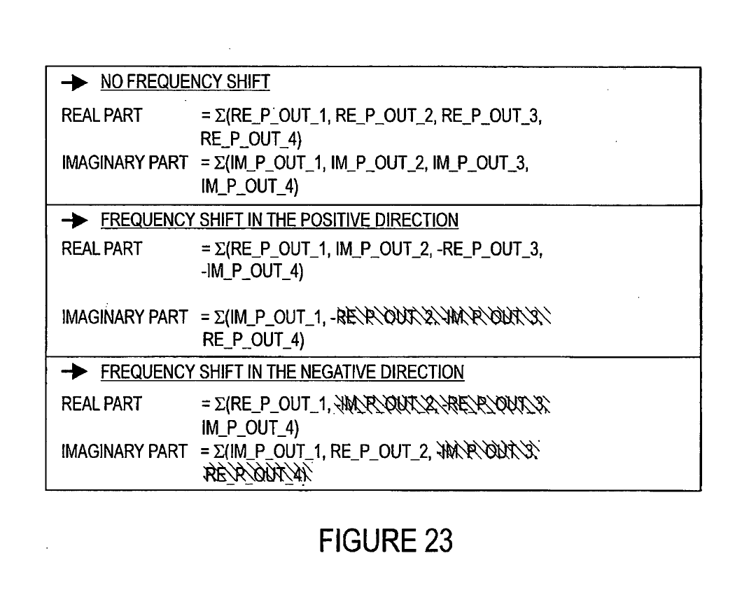

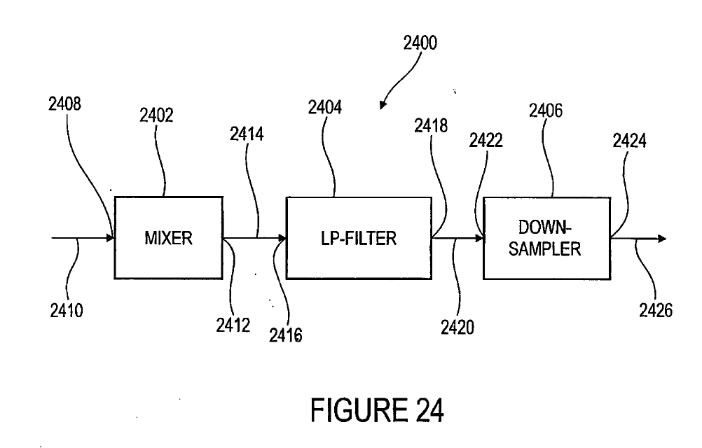

An overview over the polyphase results to be summed for the realization of a frequency shift in the positive direction, a frequency shift in the negative direction and no frequency shift is illustrated in FIG. 23.

By this it may be seen that already by a polyphase filter structure having a corresponding negation and reordering possibility, a mixer may be realized offering all functionalities of the mixer 1800 illustrated in FIG. 18, in particular of frequency mixing, low-pass filtering and downsampling. This enables performing the negation and reordering as well as the weighting using filter coefficients for realizing the low-pass filtering in any order, which results in a further flexibilization and thus in a further improvement of the applicability of the mixer. Further, by this additional flexibilization also simplifications in the circuit design or in the numerical complexity may be achieved, as now no strict adherence to the order of the individual steps is necessary, but rather a more efficient implementation in terms of circuit engineering or numerics of the fₛ/4 mixing is enabled.

As a further possibility, also a frequency converter may be realized, wherein means 112 for summing is implemented, in addition to the end signal OUT, to obtain a first output signal and a second output signal, wherein the first output signal comprises a first output frequency corresponding to a quarter of the current frequency reduced by one sixteenth of the sampling frequency, and the second output signal comprises a second output frequency corresponding to a quarter of the current frequency increased by one sixteenth of the sampling frequency, and wherein means 112 for summing is further implemented to negate an element of one of the weighting signals GS₁, GS₂, GS₃, GS₄ or exchange one element of one of the weighting signals GS₁, GS₂, GS₃, GS₄ with one element of the others of the weighting signals GS₁, GS₂, GS₃, GS₄. This offers the advantage that by the use of one single frequency converter as it was described according to the above implementation, simultaneously three different signals may be provided respectively offset from each other by one sixteenth of the sampling frequency. This option is possible in particular due to the fact that then within means for summing the negation or exchange operations are performed. This way, an efficient realization possibility may be provided when all three (or maybe only two) signals having the above-mentioned frequencies are required. This more efficient realization possibility may then consist in the fact that a numerically more simple solution instead of two or three different frequency converters may be realized. At the same time, in a hardware-technological solution of the above frequency converter, with the option to be able to output several signals at means for summing, room savings on a chip may be realized and thus a cost reduction may be caused in the manufacturing of such a frequency converter.

Depending on the conditions, the inventive method for a spectral conversion of a signal may be implemented in hardware or in software. The implementation may take place on a digital storage medium, in particular a floppy disc or a CD having electronically-readable control signals, which may cooperate with a programmable computer system so that the corresponding method is performed. In general, the invention thus also consists in a computer program product having a program code stored on a machine-readable carrier for performing the inventive method when the computer program product runs on a computer. In other words, the invention may thus be realized as a computer program having a program code for performing the method when the computer program runs on a computer.

As a conclusion it is to be noted that the digital spectral conversion for a tuning or frequency hopping usually takes place with one single digital mixer stage, wherein no cascading of several mixer stages and no sampling rate conversion (UP-/DOWN-sampling) is performed. Such a mixing with one single digital mixer stage offers the disadvantage that for the case of an unfavorable mixing proportion (i.e. a mixing not with a quarter of the sampling frequency) a substantial overhead regarding numerics or circuit technology is necessary, respectively. Apart from that, a sampling rate reduction is often performed in a separate, downstream downsampler, which further causes more overhead.

Conventionally, for example, also broadcasting standards do not comprise the required frequency raster for this mixing with the quarter sampling frequency. By this, the inventive approach offers a simplification in the frequency conversion with the quarter sampling frequency, as only the coefficients ±1 (the real and imaginary parts of an input signal) and 0 are to be considered and thus by a suitable sampling rate conversion almost any desired target frequency may be obtained. For this reason, the inventive approach offers clearly better characteristics with regard to the implementability regarding numerics or circuit engineering, and also with regard to an applicability of individual frequency subbands. Further, the inventive approach also comprises improved characteristics with regard to a processing speed of the spectral conversion, as a negation or re-sorting may be performed clearly faster than, for example, a complex multiplication.

With regard to a parallel sending and receiving it is further to be noted that such a sending and receiving requires no sampling rate conversion and no cascading. It is to be noted, that in particular with the OFDM method frequency subbands overlap. In general, an OFDM signal looks different to a signal generated using the system presented here. In particular, the spectrum in the OFDM method is so-to-speak white; in contrast to that, in the system proposed here the used frequency subbands are clearly visible. In the proposed system this results in a clearly reduced interference of the unused frequency bands, as the signal will be transmitted only on a frequency band which may be selected by a corresponding parameter setting. Further, in the OFDM method, based on the underlying FFT, always a block or frame structure, respectively, including a required frame synchronization is necessary, which increases an effort for guaranteeing the frame synchronization, which in the following leads to a higher expense with regard to numerics or circuit engineering. Apart from that, with dispersive channels (i.e. channels with multipath propagation) a guard interval is required which has a data rate-reducing effect. In the system proposed here, however, neither a frame synchronization nor a guard interval is required.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A frequency converter for a spectral conversion of a start signal having a current frequency to an end signal having a target frequency, wherein the start signal includes an I component having a plurality of I component values and a Q component having a plurality of Q component values, the frequency converter comprising:
a selector for selecting a plurality of sub-signals based on the I component or the Q component, wherein a sub-signal, depending on a raster, includes selectable I component values, and wherein another sub-signal, depending on the raster, includes selected Q component values;
a weighter for weighting each of the plurality of sub-signals, wherein the weighter for weighting is implemented to weight each of the plurality of sub-signals with respectively one weighting factor in order to obtain a plurality of weighting signals; and
a summator for summing the plurality of weighting signals to obtain the end signal having the target frequency.

2. The frequency converter according to claim 1, wherein the summator for summing comprises such a raster that an m^{th} sub-signal includes a sequence based on each fourth I component value beginning with the m^{th} I component value or a sequence based on each fourth Q component value beginning with the m^{th} Q component value and wherein m is a count index with the values 1, 2, 3, or 4.

3. The frequency converter according to claim 1, wherein the selector for selecting is implemented to negate an I component value or a Q component value.

4. The frequency converter according to claim 1, wherein the selector for selecting is implemented to provide a first, second, third and fourth sub-signal, wherein the selector for selecting further comprises a controller having a control input, wherein is implemented, in response to a signal applied to the control input, to allocate a sequence based on I component values or a sequence based on Q component values each to the first, second, third and fourth sub-signal according to a processing regulation.

5. The frequency converter according to claim 4, wherein the start signal is a sequence of time-discrete values, wherein two consecutive values are separated by a time interval defining a sampling frequency, and wherein the controller is implemented, in response to the signal applied to the control input, to cause a spectral conversion of the start signal having the current frequency to a first, second or third target frequency, wherein the first, second and third target frequency is in a predetermined connection with the current frequency and the sampling frequency.

6. The frequency converter according to claim 5, wherein the first target frequency corresponds to a quarter of the current frequency increased by one sixteenth of the sampling frequency, wherein the selector for selecting is implemented, according to the processing regulation, to allocate a sequence based on I component values to the first sub-signal, a sequence based on Q component values to the second sub-signal, a sequence based on negated I component values to the third sub-signal and a sequence based on negated Q component values to the fourth sub-signal.

7. The frequency converter according to claim 5, wherein the second target frequency corresponds to a quarter of the current frequency and is not dependent on the sampling frequency, wherein the selector for selecting is implemented, according to the processing regulation, to allocate a sequence based on I component values to the first, second, third and fourth sub-signal, respectively.

8. The frequency converter according to claim 5, wherein the third target frequency corresponds to a quarter of the current frequency reduced by one sixteenth of the sampling frequency, wherein the selector for selecting is implemented, according to the processing regulation, to allocate a sequence based on I component values to the first sub-signal, a sequence based on negated Q component values to the second sub-signal, a sequence based on negated I component values to the third sub-signal and a sequence based on Q component values to the fourth sub-signal.

9. The frequency converter according to claim 5, wherein the selector for selecting is further implemented to select a first, second, third and fourth auxiliary signal from the I component or the Q component, wherein the m^{th} auxiliary signal includes a sequence based on each fourth I component value beginning with the m^{th} I component value or a sequence based on each fourth Q component value beginning with the m^{th} Q component value, and wherein m is a count index with the values 1, 2, 3 or 4.

10. The frequency converter according to claim 6, wherein the selector for selecting is implemented to allocate a sequence based on I component values to the first auxiliary signal, a sequence based on negated I component values to the second auxiliary signal, a sequence based on negated Q component values to the third auxiliary signal and a sequence based on I component values to the fourth auxiliary signal.

11. The frequency converter according to claim 7, wherein the selector for selecting is implemented to allocate a sequence based on Q component values each to the first, second, third and fourth auxiliary signals.

12. The frequency converter according to claim 8, wherein the selector for selecting is implemented to allocate a sequence based on Q component values to the first auxiliary signal, a sequence of I component values to the second auxiliary signal, a sequence of negated Q component values to the third auxiliary signal and a sequence of negated I component values to the fourth auxiliary signal.

13. The frequency converter according to claim 1, wherein the weighter for weighting is implemented to negate a value of the plurality of sub-signals.

14. The frequency converter according to claim 1, wherein the weighter for weighting is implemented to weight a first, second, third and fourth sub-signal with one or several weighting factors each, wherein the weighter for weighting is further implemented to perform the weighting of a sub-signal according to a calculation regulation for an FIR filter.

15. The frequency converter according to claim 1, wherein the weighter for weighting is implemented to use weighting factors corresponding to the filter coefficients of an FIR low-pass filter.

16. The frequency converter according to claim 15, wherein the filter coefficients include a consecutive sequence of a first, second, third and fourth filter coefficients, wherein a first weighting factor corresponds to the first coefficient, a second weighting factor corresponds to the second coefficient, a third weighting factor corresponds to the third coefficient and a fourth weighting factor corresponds to the fourth filter coefficient.

17. The frequency converter according to claim 12, wherein the weighter for weighting is implemented to use real-valued weighting factors.

18. The frequency converter according to claim 14, wherein the weighter for weighting is implemented to use, for weighting the second sub-signal, a number of weighting factors corresponding to half a number of weighting factors for weighting the first sub-signal.

19. The frequency converter according to claim 14, wherein the weighter for weighting is implemented to delay the fourth sub-signal.

20. The frequency converter according to claim 9, wherein the weighter for weighting is implemented to weight the first auxiliary signal with a fifth weighting factors to obtain a fifth weighting signal, to weight the second auxiliary signal with a sixth weighting factor to obtain the sixth weighting signal, to weight the third auxiliary signal with a seventh weighting factor to obtain a seventh weighting signal and to weight the fourth auxiliary signal with an eighth weighting factor to obtain an eighth weighting signal.

21. The frequency converter according to claim 20, wherein the weighter for weighting is implemented to weight the first, second, third and fourth sub-signals with a first set of weighting factors including the first, second, third and fourth weighting factor and to weight the first, second, third and fourth auxiliary signals with a second set of weighting factors including the fifth, sixth, seventh and eighth weighting factor, wherein the first set of weighting factors corresponds to the second set of weighting factors.

22. The frequency converter according to claim 19, wherein further the summator for summing is further implemented to add the fifth, sixth, seventh and eighth weighting signal to obtain a complementary signal having the target frequency.

23. The frequency converter according to claim 22, wherein the end signal includes a plurality of end signal values and the complementary signal includes a plurality of complementary signal values, wherein the frequency converter further comprises:
further the selector for selecting a first, second, third and fourth sub-signal from the end signal or the complementary signal, wherein the m^{th} sub-signal includes each fourth end signal value beginning with the m^{th} end signal value, or each fourth complementary signal value beginning with the m^{th} complementary signal value, wherein m is a count variable with the values 1, 2, 3 or 4;
the weighter for weighting the first, second, third and fourth sub-signal, wherein the weighter for weighting is implemented to weight the first sub-signal with a first factor to obtain a first factor signal, to weight the second sub-signal with a second factor to obtain a second factor signal, to weight the third sub-signal with a third factor to obtain a third factor signal and to weight the fourth sub-signal with a fourth factor to obtain a fourth factor signal; and
a summator for summing the first, second, third and fourth factor signals to obtain an output signal having an output frequency.

24. The frequency converter according to claim 1, wherein the summator for summing is implemented, in addition to the end signal, to obtain a first output signal and a second output signal, wherein the first output signal comprises a first output frequency corresponding to a quarter of the current frequency reduced by one sixteenth of the sampling frequency and the second output signal comprises a second output frequency corresponding to a quarter of the current frequency increased by one sixteenth of the sampling frequency, and wherein the summator for summing is further implemented to negate an element of the weighting signals or to exchange an element of one of the weighting signals with an element of another one of the weighting signals.

25. A method for a spectral conversion of a start signal having a current frequency to an end signal having a target frequency, wherein the start signal includes an I component having a plurality of I component values and a Q component having a plurality of Q component values, and wherein the method for a spectral conversion comprises:
selecting a plurality of sub-signals based on the I component or the Q component, wherein a sub-signal, depending on a raster, includes selectable I component values, and wherein another sub-signal, depending on the raster, includes selected Q component values;
weighting each of the plurality of sub-signals, wherein each of the plurality of sub-signals is weighted with one weighting factor each to obtain a plurality of weighting signals; and
summing the plurality of weighting signals to obtain the end signal having the target frequency.

26. A computer program for performing the method, when the computer program runs on a computer, for a spectral conversion of a start signal having a current frequency to an end signal having a target frequency, wherein the start signal includes an I component having a plurality of I component values and a Q component having a plurality of Q component values, and wherein the method for a spectral conversion comprises:
selecting a plurality of sub-signals based on the I component or the Q component, wherein a sub-signal, depending on a raster, includes selectable I component values, and wherein another sub-signal, depending on the raster, includes selected Q component values;
weighting each of the plurality of sub-signals, wherein each of the plurality of sub-signals is weighted with one weighting factor each to obtain a plurality of weighting signals; and
summing the plurality of weighting signals to obtain the end signal having the target frequency.
